(19) United States
(12) Patent Application Publication
(10) Pub. No.: US 2013/0080826 A1
(43) Pub. Date: Mar. 28, 2013

(54) SEMICONDUCTOR DEVICE VERIFYING SIGNAL SUPPLIED FROM OUTSIDE

(71) Applicant: Elpida Memory, INC., Tokyo (JP)

(72) Inventor: Chikara Kondo, Tokyo (JP)

(73) Assignee: Elpida Memory, INC., Tokyo (JP)

(21) Appl. No.: 13/629,312

(22) Filed: Sep. 27, 2012

(30) Foreign Application Priority Data
Sep. 28, 2011 (JP) 2011-212144

(51) Int. Cl. G06F 11/20

(52) U.S. Cl. 714/6.2; 714/E11.085

(57) ABSTRACT

Disclosed herein is a semiconductor device that includes a verification circuit and an error processing circuit. the verification circuit verifies second bits of an external command to generate the verification result signal. The error processing circuit supplies a follow-up signal to a bank control circuit after a lapse of a first period and a second period when the verification result signal indicates a fail state during a write operation. The first period corresponds to a write latency indicating a period between when a write command is generated and when a data associated with the write command is supplied from outside. The second period corresponds to a write recovery latency indicating a period between when the bank control circuit issues a write execution signal to start writing the data to memory cells and when the write operation is completed.

### BACKGROUND OF THE INVENTION

1. Field of the Invention

The present invention relates to a semiconductor device and an information processing system including the same, and more particularly to a semiconductor device that can verify whether a control signal supplied from outside, such as a command signal, has proper logic and an information processing system including the same.

2. Description of Related Art

Semiconductor memory devices typified by a dynamic random access memory (DRAM) receive an address signal and a command signal supplied from a controller, and access their memory cell array based on the signals. More specifically, an address signal supplied to a semiconductor memory device is latched into an address latch circuit, and memory cells to be accessed are identified based on the address signal. A command signal supplied to the semiconductor memory device is decoded by a command decoder, and an access type is identified based on the command signal.

Access types include a row access based on an active command, a read access based on a read command, and a write access based on a write command. For DRAMs, a precharge operation based on a precharge command is also included. A precharge operation refers to an operation for deactivating a memory cell array which has been activated in response to an active command. Precharge operations can be performed not only based on a precharge command but also automatically. Specifically, if a read command or write command is issued with a predetermined address terminal (for example, an A10 pin) set to a high level, a precharge operation is automatically performed after the end of the read operation or write operation. Such an operation is referred to as an auto precharge operation (see “4G bits DDR3 SDRAM” (Document No. E1705E40 (Ver. 4.0)), URL http://www.elpida.com/pdfs/E1705E40.pdf).

DDR4 (Double Data Rate 4) DRAMs have recently been proposed as DRAMs even faster than DDR3 (Double Data Rate 3) DRAMs. DDR4 DRAMs support a new function called “CA parity”. The CA parity refers to the function of verifying whether an address signal and a command signal supplied from a controller have proper logic. Such a function can be used to detect inversion of logic of bits constituting the address signal and the command signal, i.e., a parity error occurring during transmission if any.

What processing to perform on the DRAM side in the event of a parity error is important in view of improving the reliability of semiconductor devices in practical use. For example, when a parity error occurs, it is important how to handle effective commands issued before and how to perform auto precharge processing if a command issued before includes an auto precharge. DRAMs that can perform appropriate processing in the event of a parity error are demanded. Such a demand is not only on DDR4 DRAMs but also on semiconductor devices in general that can verify control signals supplied from outside.

### SUMMARY

In one embodiment, there is provided a semiconductor device on one chip that includes: a first external terminal receiving a command signal; a second external terminal receiving an address signal; a third external terminal receiving a parity bit related to at least one of the command signal and the address signal; a memory cell array including a first group of memory cells activated by a first selection signal and a second group of memory cells activated by a second selection signal; a verification circuit configured to be responsive to the parity bit and the related one of the command signal and the address signal to produce an error signal; an error processing circuit configured to be responsive to the error signal to produce a follow-up signal; and a control circuit configured to be responsive to the follow-up signal to deactivate the first and second groups of memory cells.

In another embodiment, there is provided a semiconductor device on one chip: a first external terminal supplied with a command signal; a second external terminal supplied with an address signal; a third external terminal supplied with a verification signal; a memory cell array that includes a plurality of memory cells; and an access control circuit that receives the address signal indicating an address of at least one of the memory cells to be accessed and the command signal indicating an access type, and accessing the memory cell array based on the address signal and the command signal, wherein the access control circuit includes: an active control circuit activating the memory cell array based on the address signal and the command signal; a verification circuit that verifies the address signal and the command signal based on the verification signal to output a verification result signal; and an error processing circuit that deactivates the memory cell array after a lapse of a predetermined time from a first time point when the verification result signal indicates a fail state at the first time point.

In still another embodiment, there is provided a semiconductor device that includes: a command decoder generating an internal command including a write command based on a verification result signal and an external command, the external command including a first bit and a plurality of second bits supplied from outside; a verification circuit verifying the second bits to generate the verification result signal, the verification result signal indicating a fail state when the second bits include an error; a plurality of memory banks each includes a plurality of memory cells, the memory banks being non-exclusively accessed based on the internal command; a bank control circuit performing an activation operation to activate one or ones of the memory banks, a deactivation operation to deactivate one or ones of the memory banks, a read operation to read data from one of the memory banks, and a write operation to write data into one of the memory banks based on the internal command; and an error processing circuit supplying a follow-up signal to the bank control circuit after a lapse of a first period and a second period when the verification result signal indicates the fail state during the write operation. The first period corresponds to a write latency indicating a period between when the write command is generated by the command decoder and when the data associated with the write command is supplied from outside. The second period corresponds to a write recovery latency indicating a period between when the bank control circuit issues a write execution signal to start writing the data to the memory cells and when the write operation is completed.

According to the present invention, when a so-called parity error or other defect is detected, the memory cell array is not immediately deactivated but is deactivated after a lapse of a predetermined time. The memory cell array can thus be deactivated after previously-issued commands (commands that are issued before the detection of the defect) are properly executed. This can improve the reliability of the semiconductor device in practical use.

### BRIEF DESCRIPTION OF THE DRAWINGS

FIG. 1 is a block diagram for explaining the principle of an embodiment of the present invention;

FIG. 2 is an example of a truth table for explaining an operation of a command decoder shown in FIG. 1;

FIG. 3 is a block diagram indicative of an embodiment of a semiconductor device 10a according to a preferred first embodiment of the present invention and mainly shows details of circuit blocks belonging to an access control circuit shown in FIG. 1;

FIG. 4 is a circuit diagram for explaining the function of a verification circuit shown in FIG. 3;

FIG. 5 is a circuit diagram indicative of an embodiment of a parity latency circuit shown in FIG. 3;

FIG. 6A is a timing chart for explaining the operation of the parity latency circuit shown in FIG. 3 in the parity OFF mode;

FIG. 6B is a timing chart for explaining the operation of the parity latency circuit shown in FIG. 3 in the parity ON mode;

FIG. 7 is a block diagram for explaining signals input and output to/from a bank control circuit shown in FIG. 3;

FIG. 8 is a circuit diagram indicative of an embodiment of essential parts of an error processing circuit shown in FIG. 3;

FIG. 9 is a circuit diagram indicative of an embodiment of a column control circuit shown in FIG. 7;

FIG. 10 is a timing chart for explaining the operation of the column control circuit and shows an example that the write latency WL is set to nine clock cycles;

FIG. 11 is a circuit diagram indicative of an embodiment of an auto precharge control circuit shown in FIG. 7;

FIG. 12 is a timing chart for explaining the operation of the column control circuit;

FIG. 13 is a table indicative of an embodiment of the relationship between a set value of a mode register shown in FIG. 3, a write recovery latency WR, and a read recovery latency RR;

FIG. 14 is a circuit diagram indicative of an embodiment of an active control circuit shown in FIG. 7;

FIG. 15 is a diagram indicative of an embodiment of banks B0 to B15;

FIG. 16 is a timing chart for explaining the operation of the semiconductor device 10a according to the first embodiment and shows operations in the parity ON mode;

FIG. 17 is a block diagram indicative of an embodiment of a semiconductor device 10b according to a second preferred embodiment of the present invention and mainly shows details of circuit blocks belonging to the access control circuit 20 shown in FIG. 1;

FIG. 18 is a block diagram for explaining signals input and output to/from a bank control circuit shown in FIG. 17;

FIG. 19 is a circuit diagram indicative of an embodiment of essential parts of an error processing circuit shown in FIG. 18;

FIG. 20 is a circuit diagram indicative of an embodiment of an auto precharge control circuit shown in FIG. 18;

FIG. 21 is a timing chart for explaining operations in a case where a parity error occurs when the column control circuit is at rest;

FIG. 22 is a timing chart for explaining operations in a case where a parity error occurs when the column control circuit is in operation; and

FIG. 23 is a timing chart for explaining operations when a parity error occurs when the auto precharge control circuit is in operation.

### DETAILED DESCRIPTION OF THE EMBODIMENTS

A representative example of the technical concept of an embodiment of the present invention for solving the problem will be described below. It will be understood that what the present invention claims are not limited to such a technical concept but set forth in the claims of the present invention. The technical concept of the present embodiment includes: verifying an address signal and a command signal based on a verification signal; and if the address signal or the command signal is determined to be erroneous, deactivating the memory cell array as a routine of status error processing after write data is properly written to memory cells based on a previously-issued write command or after read data is read out from memory cells based on a previously-issued read command and properly restored to the memory cells. In other words, commands that have yet to be processed are identified at the time of occurrence of error, and the completion of the processing of the commands is made sure before a routine for error processing is started. Consequently, even if a previously-issued write command or read command is in operation (i.e., in an incomplete state) at the time of occurrence of error, a precharge operation can be performed at timing appropriate as error processing.

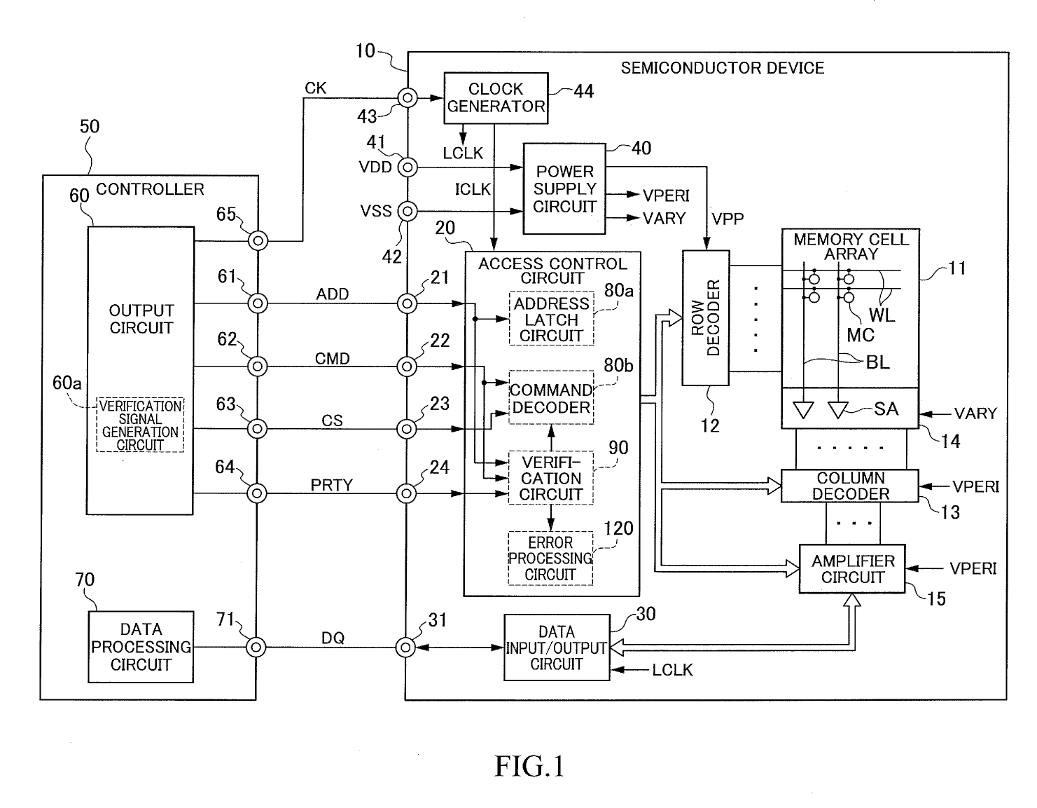

Referring now to FIG. 1, an information processing system including a controller 50 and a semiconductor device 10 is shown. The semiconductor device 10 shown in FIG. 1 is a semiconductor memory device such as a DRAM. The semiconductor device 10 includes a memory cell array 11. The memory cell array 11 includes a plurality of word lines WL and a plurality of bit lines BL which intersect each other. Memory cells MC are arranged at the intersections. The word lines WL are selected by a row decoder 12. The bit lines BL are selected by a column decoder 13. The bit lines BL are connected to respective corresponding sense amplifiers SA in a sense circuit 14. Bit lines BL selected by the column decoder 13 are connected to an amplifier circuit 15 through sense amplifiers SA.

The operation of the row decoder 12, the column decoder 13, the sense circuit 14, and the amplifier circuit 15 is controlled by an access control circuit 20. An operation timing of the access control circuit 20 is controlled based on an internal clock signal ICLK. The internal clock signal ICLK is generated by a clock generator 44 based on an external clock signal supplied via a clock terminal 43. The clock generator 44 also generates an internal clock signal LCLK. The internal clock signal LCLK is supplied to a data input/output circuit 30. An address signal ADD, a command signal CMD, a chip select signal CS, and a verification signal PRTY are supplied to the access control circuit 20 through terminals 21 to 24. Based on such signals, the access control circuit 20 controls the row decoder 12, the column decoder 13, the sense circuit 14, the amplifier circuit 15, and the data input/output circuit 30. In the present embodiment, a bit used as the chip select signal CS may be referred to as a “first bit”, and a plurality of bits that constitute the command signal CMD may be referred to as “second bits” in the present embodiment.

Specifically, if the command signal CMD is an active command, the address signal ADD is supplied to the row decoder 12. In response to this, the row decoder 12 selects a word line WL that is designated by the address signal ADD, whereby corresponding memory cells MC are connected to respective bit lines BL. The access control circuit 20 then activates the sense circuit 14 at predetermined timing.

On the other hand, if the command signal CMD is a read command or a write command, the address signal ADD is supplied to the column decoder 13. In response to this, the column decoder 13 connects bit lines EL designated by the address signal ADD to the amplifier circuit 15. Consequently, in a read operation, read data DQ read from the memory cell array 11 through sense amplifiers SA is output from a data terminal 31 to outside through the amplifier circuit 15 and the data input/output circuit 30. In a write operation, write data DQ supplied from outside through the data terminal 31 and the data input/output circuit 30 is written to memory cells MC through the amplifier circuit 15 and sense amplifiers SA.

As shown in FIG. 1, the access control circuit 20 includes an address latch circuit 80a, a command decoder 80b, a verification circuit 90 and an error processing circuit 120.

The address latch circuit 80a is a circuit that latches the address signal ADD supplied through the address terminal 21. As described above, the address signal ADD latched in the address latch circuit 80a is supplied to the row decoder 21 or the column decoder 13 depending on the content of the command signal CMD.

The command decoder 80b is a circuit that decodes the command signal CMD supplied through the command terminal 22. The command signal CMD includes, though not limited to, a plurality of bits of control signals including an active signal ACT, a row address strobe signal RAS, a column address strobe signal CAS, and a write enable signal WE. Access types are defined by the combinations of the logic levels of such signals. Examples of the access types include a row access based on an active command, a read access based on a read command, a write access based on a write command, and a status quo operation based on a NOP command.

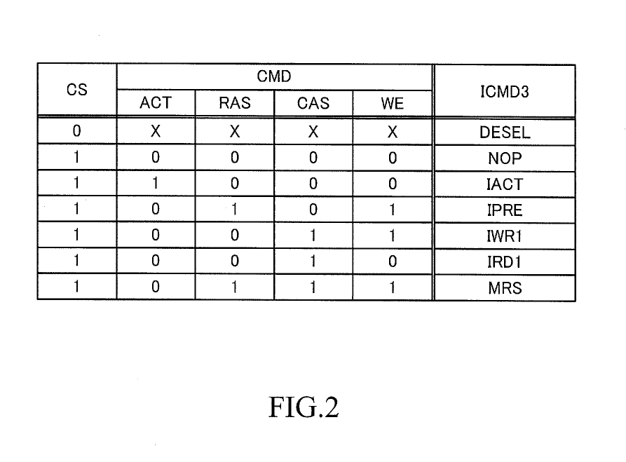

Turning to FIG. 2, in this example, combinations of the chip select signal CS and the command signal CMD produce internal commands including a DESEL command, the NOP command, an active command IACT, a precharge command IPRE, a write command IWR1, a read command IRD1, and a mode register setting command MRS.

The DESEL command is a command that is generated when the chip select signal CS is in an inactive state. When the DESEL command is issued, the access control circuit 20 performs no access operation. The NOP command is a command that is generated when the chip select signal CS is in an active state and all the bits of the command signal CMD are at a low level. Again, when the NOP command is issued, the access control circuit 20 performs no access operation.

When the active command IACT, the write command IWR1, and the read command IRD1 are issued, the access control circuit 20 performs the foregoing operations to make a row access, a write access, and a read access, respectively. The precharge command IPRE is a command for deactivating the memory cell array 11 which has been activated by the active command IACT. The mode register setting signal MRS is an internal command for rewriting a set value of the mode register described later.

The address latch circuit 80a and the command decoder 80b are activated based on the chip select signal CS supplied through the chip select terminal 23. If the chip select signal CS is in an inactive state, the address latch circuit 80a and the command decoder 80b are also deactivated. In such a case, the input address signal ADD and command signal CMD are disabled. In the present embodiment, the inactive state of the chip select signal CS may also be considered as a kind of command and referred to as a DESEL command. When a DESEL command is issued, the access control circuit 20 performs no access operation. This provides the same result as when a NOP command is issued.

The verification circuit 90 is a circuit that verifies the address signal ADD and the command signal CMD based on the verification signal PRTY supplied through the verification terminal 24. The verification method is not limited in particular. Preferred examples include a method of determining whether the number of high-level (or low-level) bits included in a plurality of bits constituting the address signal ADD and the command signal CMD is an even number or an odd number, and collating the determination with the verification signal PRTY. In such a case, the verification signal PRTY corresponds to a so-called parity bit, which may consist of only one bit.

The error processing circuit 120 is a circuit that performs error processing when the result of the verification by the verification circuit 90 is a fail. The error processing according to the present embodiment includes processing for forcefully deactivating the memory cell array 11. An example of the processing for deactivating the memory cell array 11 includes restoring the memory cell array 11 where a word line WL is selected by an active command IACT to a precharge state, i.e., restoring all the word lines WL to an inactive state. If the memory cell array 11 is divided into a plurality of banks, all the banks are preferably restored to an inactive state. The purpose of such processing is to prevent data retained in the memory cell array 11 from being corrupted by an erroneous command or an erroneous address when the result of the verification by the verification circuit 90 is a fail.

If the result of the verification by the verification circuit 90 is a fail, the error processing circuit 120 deactivates the memory cell array 11 not unconditionally but after a wait for proper execution of effective commands issued before. More specifically, if a command issued before is a write command, the memory cell array 11 is deactivated after a wait for write data to be properly written to the memory cells MC. If a command issued before is a read command, the memory cell array 11 is deactivated after a wait for read-out read data to be restored to the memory cells MC.

The reason is that write data input from the controller 50 is not immediately written to the memory cells MC, but a predetermined write recovery time is needed for the amplifier circuit 15 and the sense circuit 40 to actually finish writing the write data to the memory cells MC. In the case of a DRAM, a read operation means a destructive read operation. When read data is output to the controller 50, a predetermined read recovery time is needed to restore the read data to the memory cells MC.

In view of the foregoing, in the present embodiment, the memory cell array 11 is deactivated after a wait for a write recovery time and a read recovery time if the verification circuit 90 produces a fail determination.

The foregoing circuit blocks operate with respective predetermined internal voltages as their power supply. The internal power supplies are generated by a power supply circuit 40 shown in FIG. 1. The power supply circuit 40 receives an external potential VDD and a ground potential VSS supplied through power supply terminals 41 and 42, respectively. Based on the potentials, the power supply circuit 40 generates internal voltages VPP, VPERI, VARY, etc. The internal potential VPP is generated by boosting the external potential VDD. The internal potentials VPERI and VARY are generated by stepping down the external potential VDD.

The internal voltage VPP is a voltage that is mainly used in the row decoder 12. The row decoder 12 drives a word line WL that is selected based on the address signal ADD to the VPP level, thereby making the cell transistors included in memory cells MC conducting. The internal voltage VARY is a voltage that is mainly used in the sense circuit 14. The sense circuit 14, when activated, drives either one of each pair of bit lines to the VARY level and the other to the VSS level, thereby amplifying read data that is read out. The internal voltage VPERI is used as the operating voltage of most of the peripheral circuits such as the access control circuit 20. The use of the internal voltage VPERI lower than the external voltage VDD as the operating voltage of the peripheral circuits reduces the power consumption of the semiconductor device 10.

Now, the controller 50 includes an output circuit 60 and a data processing circuit 70. The output circuit 60 is a circuit for supplying the address signal ADD, the command signal CMD, the chip select signal CS, the verification signal PRTY and the external clock signal CK to the semiconductor device 10 through terminals 61 to 65. The data processing circuit 70 is a circuit that processes read data DQ and write data DQ input/output through a data terminal 71.

When accessing the semiconductor device 10, the controller 50 activates the chip select signal CS and supplies the address signal ADD and the command signal CMD. The controller 50 also supplies the verification signal PRTY that is generated based on the address signal ADD and the command signal CMD. The verification signal PRTY is generated by a verification signal generation circuit 60a. Suppose that the verification signal PRTY is a parity bit. If the number of high-level bits included in the plurality of bits constituting the address signal ADD and the command signal CMD is an even number, the verification signal generation circuit 60a sets the verification signal PRTY to a low level. If the number of high-level bits is an odd number, the verification signal generation circuit 60a sets the verification signal PRTY to a high level. In other words, the plurality of bits constituting the address signal ADD, the command signal CMD, and the verification signal PRTY always include an even number of high-level bits. The timing for the controller 50 to supply the chip select signal CS, the address signal ADD, the command signal CMD, and the verification signal PRTY to the semiconductor 10 is not limited in particular. All the signals may be simultaneously supplied. The chip select signal CS may be issued alone in advance, followed by the issuance of the adders signal ADD, the command signal CMD, and the verification signal PRTY after a lapse of predetermined time.

Each time the controller 50 accesses the semiconductor device 10, the verification circuit 90 included in the semiconductor device 10 verifies the address signal ADD and the command signal CMD. If the verification result shows that the address signal ADD and the command signal CMD include no defect, the verification circuit 90 allows the command decoder 80b to perform a decoding operation on the command signal CMD. Consequently, an access operation selected by the command signal CMD is performed.

On the other hand, if the verification result shows that the address signal ADD or the command signal CMD include a defect, the error processing circuit 120 deactivates the memory cell array 11 as described above. In this case, though not limited to, it is preferable that the verification circuit 90 controls the command decoder 80b so that the command decoder 80b performs the same operation as in the case where a DESEL command or a NOP command is issued.

The case where a DESEL command is issued refers to that the chip select signal CS is in an inactive state. To make the command decoder 80b perform the same operation as in the case where a DESEL command is issued, the chip select signal CS supplied from outside may be forcefully converted inside from an active state into an inactive state. The case where a NOP command is issued refers to that the chip select signal CS is in an active state and a combination of command signals CMD indicates a NOP command. To make the command decoder 80b perform the same operation as in the case where a NOP command is issued, the combination of command signals CMD supplied from outside may be forcefully converted inside into that of a NOP command.

For example, suppose that a bit is inverted while the address signal ADD and the command signal CMD are being transmitted from the controller 50 to the semiconductor device 10. In such a case, the verification circuit 90 detects the error and the memory cell array 11 is deactivated after a lapse of a predetermined time. In other words, the memory cell array 11 is deactivated after an effective command that is issued before the detection of the error is properly executed and the recovery time has elapsed. Consequently, the command issued before the detection of the error is properly processed, and the data retained in the memory cell array 11 is prevented from being corrupted by the erroneous command or erroneous address. The error-causing command can be converted into a DESEL command or NOP command to avoid an effective access to the memory cell array 11. This precludes the problem of executing an erroneous command or overwriting the memory cell array 11 with erroneous data.

Preferred embodiments of the present invention will be explained below in detail with reference to the accompanying drawings.

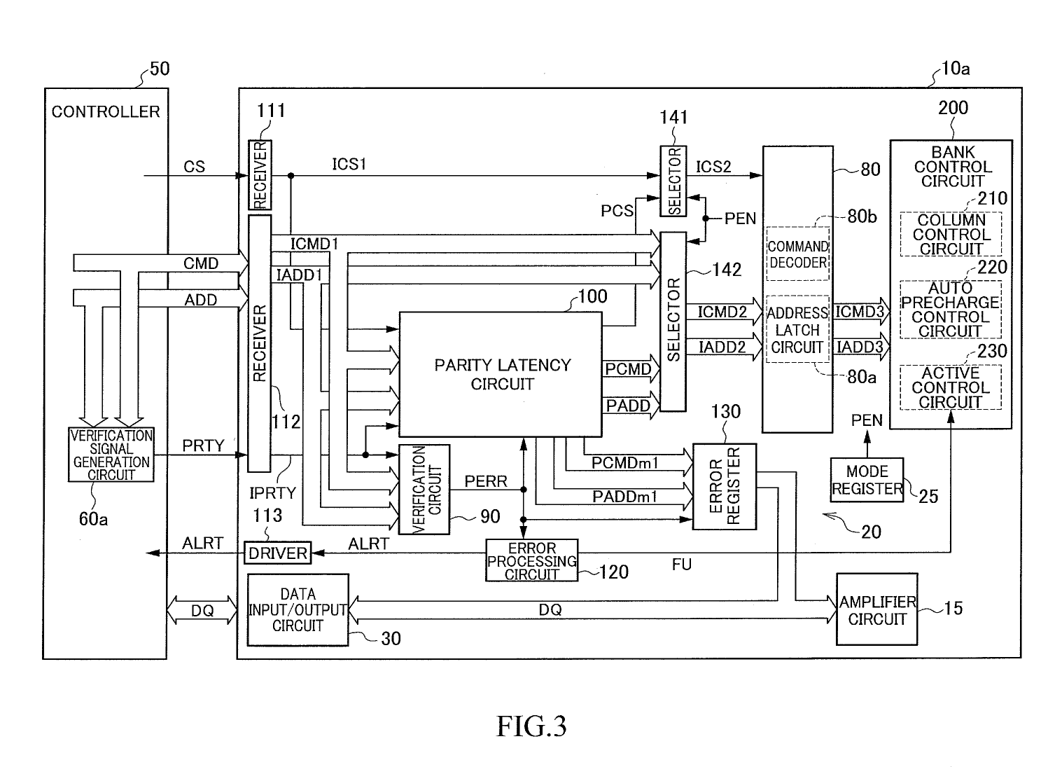

Turning to FIG. 3, the access control circuit 20 includes receivers 111 and 112. The receiver 111 receives the chip select signal CS supplied from the controller 50 and generates an internal chip select signal ICS1. The receiver 112 receives the address signal ADD, the command signal CMD, and the verification signal PRTY supplied from the controller 50 and generates an internal address signal IADD1, an internal command signal ICMD1, and an internal verification signal IPRTY. The internal address signal IADD1, the internal command signal ICMD1, and the internal verification signal IPRTY are all supplied to the verification circuit 90.

In the present embodiment, the verification signal PRTY is a parity bit which indicates whether the number of high-level bits among the plurality of bits constituting the address signal ADD and the command signal CMD is an even number or an odd number. Specifically, if the number of high-level bits among the plurality of bits constituting the address signal ADD and the command signal CMD is an even number, the verification signal PRTY becomes a low level. If the number of high-level bits is an odd number, the verification signal PRTY becomes a high level. Therefore, the plurality of bits including the address signal ADD, the command signal CMD, and the verification signal PRTY must always include an even number of high-level bits. If the number of high-level bits is an odd number, it means that either the address signal ADD or the command signal CMD is erroneous.

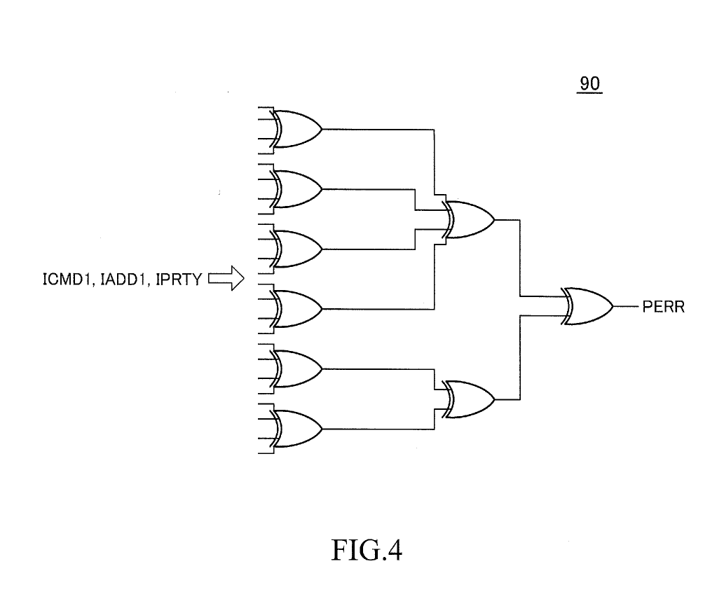

Turning to FIG. 4, the verification circuit 90 calculates exclusive ORs of the plurality of bits constituting the address signal ADD and the command signal CMD and the bit constituting the verification signal PRTY by two bits. The verification circuit 90 further calculates exclusive ORs of the resultants to finally obtain a 1-bit calculation result. An exclusive OR operation produces a low level if two input bits coincide with each other (i.e., if the number of high-level bits is an even number), and a high level if the two input bits do not coincide with each other (i.e., if the number of high-level bits is an odd number). If the final result bit is at a low level, it shows that the number of high-level bits in the plurality of input bits is an even number. On the other hand, if the final result bit is at a high level, it shows that the number of high-level bits in the plurality of input bits is an odd number. The bit finally resulting from the verification circuit 90 constitutes a parity error signal PERR. The parity error signal PERR of high level indicates the occurrence of an error. In the present embodiment, the parity error signal PERR may be referred to as a “verification result signal”. The parity error signal PERR is supplied to a parity latency circuit 100, an error processing circuit 120, an error register 130, and the like shown in FIG. 3.

The parity latency circuit 100 retains the internal chip select signal ICS1, the internal address signal IADD1, and the internal command signal ICMD1 as long as needed for the verification circuit 90 to perform a parity check (i.e., as long as a verification period, or parity latency). After a lapse of the parity latency, the parity latency circuit 100 outputs the retained signals as an internal chip select signal PCS, an internal address signal PADD, and an internal command signal PCMD, respectively.

The error processing circuit 120 is a circuit that performs error processing when the parity error signal PERR is activated to a high level. The error processing circuit 120 activates a follow-up signal FU after a lapse of a predetermined time since the parity error signal PERR is activated to a high level. The follow-up signal FU is supplied to an active control circuit 230 included in a bank control circuit 200. The error processing circuit 120 will be described in detail later.

In the present embodiment, when the parity error signal PERR is activated, the error processing circuit 120 generates an alert signal ALRT. The alert signal ALRT is output to outside through a driver 113. The alert signal ALRT output outside is supplied to the controller 50, whereby the controller 50 is informed of the occurrence of the parity error.

The error register 130 is a circuit that retains the address signal ADD and the command signal CMD pertaining to the parity error when the parity error signal PERR is activated to a high level. In fact, the error register 130 retains an internal address signal PADDm1 and an internal command signal PCMDm1 which are intermediate products of the delaying by the parity latency circuit 100. The internal address signal PADDm1 and the internal command signal PCMDm1 retained in the error register 130 are output to outside through the data input/output circuit 30. The internal address signal PADDm1 and the internal command signal PCMDm1 output outside are supplied to the controller 50, whereby the controller 50 is informed of which address signal ADD or command signal CMD has caused the parity error.

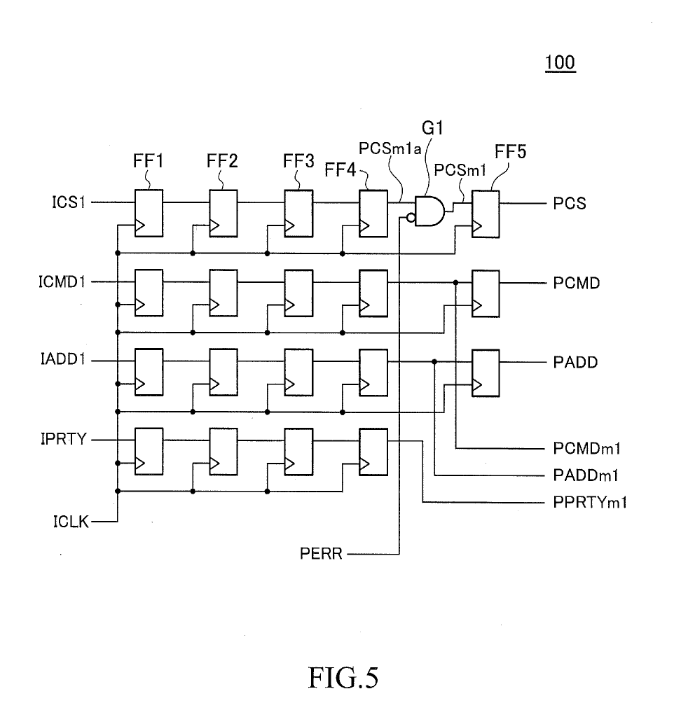

Turning to FIG. 5, the parity latency circuit 100 has a latency of five clock cycles. The latency need not be fixed and may be variable depending on a mode setting. The mode setting is performed by setting a predetermined mode signal into a mode register 25 shown in FIG. 3. Set values of the mode register 25 include a set value about whether to enable or disable a parity check on the address signal ADD and the command signal CMD. If an operation mode for enabling the parity check (parity ON mode) is set, a mode signal PEN is activated to a high level, for example. If an operation mode for disabling the parity check (parity OFF mode) is set, the mode signal PEN is deactivated to a low level, for example.

The parity latency circuit 100 uses an internal clock signal ICLK, which is generated based on an external clock signal supplied from the controller 50. In the present example, five stages of shift registers are provided on the path that receives the internal chip select signal ICS1 and outputs the internal chip select signal PCS. The internal chip select signal PCS is thus output five clock cycles after the reception of the internal chip select signal ICS1. The same holds for the internal command signal ICMD1 and the internal address signal IADD1, which are output through five stages of shift registers as the internal command signal PCMD and the internal address signal PADD, respectively.

In the parity latency circuit 100 shown in FIG. 5, the path for counting the internal chip select signal ICS1 includes an AND gate circuit G1. The AND gate circuit G1 is inserted between the output node of the flip-flop circuit FF4 at the fourth stage and the input node of the flip-flop circuit FF5 at the fifth stage. If the parity error signal PERR is at a low level, the AND gate circuit G1 simply supplies a signal PCSm1a output from the flip-flop circuit FF4 at the fourth stage to the flip-flop circuit FF5 at the fifth stage. On the other hand, if the parity error signal PERR is at a high level, the AND gate circuit G1 forcefully deactivates its signal PCSm1, which is supplied to the flip-flop circuit FF5 at the fifth stage, to a low level regardless of the signal PCSm1 output from the flip-flop circuit FF4 at the fourth stage.

In the present example, the parity check by the verification circuit 90 needs to be completed before the flip-flop circuit FF5 at the fifth stage latches the signal PCSm1. If the parity check by the verification circuit 90 shows the absence of a parity error, the internal chip select signal PCS is properly output at the fifth clock cycle. On the other hand, if the parity check by the verification circuit 90 shows the occurrence of a parity error, the internal chip select signal PCS output at the fifth clock cycle is forcefully deactivated to a low level. In other words, the corresponding command is converted into a DESEL command.

Meanwhile, the internal command signal ICMD1 and the internal address signal IADD1 are output as the internal command signal PCMD and the internal address signal PADD at the fifth clock cycle regardless of the result of the parity check. Note that the signals PCMDm1 and PADDm1 output from the flip-flop circuits FF4 at the fourth stages are supplied to the foregoing error register 130. The same holds for an internal verification signal PPRTYm1 which is synchronous with the signals PCMDm1 and PADDm1.

The internal chip select signal PCS output from the parity latency circuit 100 is input to one of the input nodes of a selector 141 shown in FIG. 3. The internal chip select signal ICS1 not passed through the parity latency circuit 100 is supplied to the other input node of the selector 141.

The selector 141 outputs either one of the signals PCS and ICS1 as an internal chip select signal ICS2 based on the mode signal PEN. Specifically, if the mode signal PEN is activated to a high level (set to the parity ON mode), the internal chip select signal PCS is selected. If the mode signal PEN is deactivated to a low level (set to the parity OFF mode), the internal chip select signal ICS1 is selected. The internal chip select signal ICS2 output as the result of selection is supplied to a first input node of a circuit block 80. The circuit block 80 is a circuit block that includes the address latch circuit 80a and the command decoder 80b shown in FIG. 1. The circuit block 80 is activated based on the internal chip select signal ICS2.

Similarly, the internal command signal PCMD and the internal address signal PADD output from the parity latency circuit 100 are input to one of the input nodes of a selector 142. The internal command signal ICMD1 and the internal address signal IADD1 not passed through the parity latency circuit 100 are supplied to other input node of the selector 142.

The selector 142 outputs either pair of the signals as an internal command signal ICMD2 and an internal address signal IADD2 based on the mode signal PEN. Specifically, if the mode signal PEN is activated to a high level (set to the parity ON mode), the internal command signal PCMD and the internal address signal PADD are selected. If the mode signal PEN is deactivated to a low level (set to the parity OFF mode), the internal command signal ICMD1 and the internal address signal IADD1 are selected. The internal command signal ICMD2 and the internal address signal IADD2 output as the result of selection are supplied to a second input node of the circuit block 80. Consequently, the internal address signal IADD2 is latched into the address latch circuit 80a, and the internal command signal ICMD2 is decoded by the command decoder 80b. The internal address signal IADD2 latched into the address latch circuit 80a is output as an internal address signal IADD3. The command decoder 80b decodes the internal command signal ICMD2 to generate an internal command signal ICMD3. The internal address signal IADD3 and the internal command signal ICMD3 are supplied to the bank control circuit 200 described later.

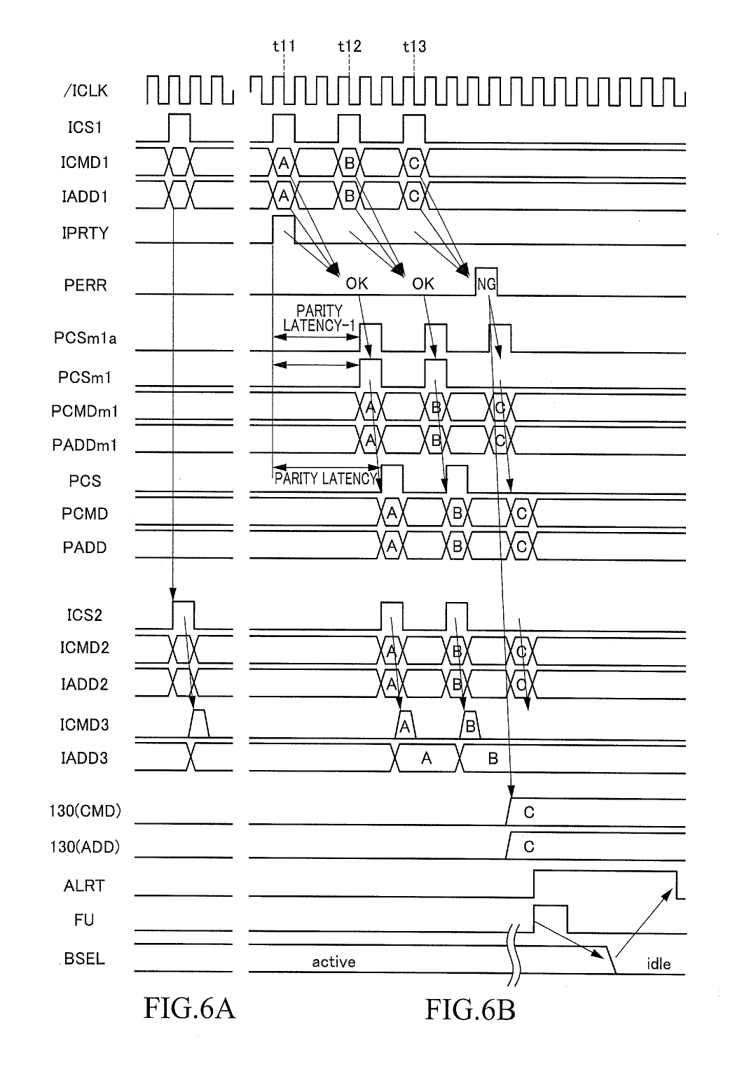

Turning to FIG. 6A, in the parity OFF mode, the mode signal PEN is deactivated to a low level. The selector 141 therefore selects the internal chip select signal ICS1. The selector 142 selects the internal command signal ICMD1 and the internal address signal IADD1. As shown FIG. 6A, the internal chip select signal ICS1, the internal command signal ICMD1, and the internal address signal IADD1 are simply supplied to the circuit block 80 as the internal chip select signal ICS2, the internal command signal ICMD2, and the internal address signal IADD2. The circuit block 80 performs a decoding operation of the internal command signal ICMD2 and a latch operation of the internal address signal IADD2. Consequently, the internal command signal ICMD3 and the internal address signal IADD3 are output without a wait for the parity latency, and the signals are supplied to the bank control circuit 200.

Turning to FIG. 6B, in the parity ON mode, the mode signal PEN is activated to a high level. The selector 141 therefore selects the internal chip select signal PCS. The selector 142 selects the internal command signal PCMD and the internal address signal PADD. In the example shown in FIG. 6B, the internal chip select signal ICS1, the internal command signal ICMD1, and the internal address signal IADD1 occur at times t11, t12, and t13.

Suppose that the internal command signal ICMD1 and the internal address signal IADD1 occurring at time t11 include an odd number of high-level bits and an even number of high-level bits, respectively. The total number of high-level bits is an odd number. Since the corresponding internal verification signal IPRTY is correctly at a high level, the verification circuit 90 deactivates the parity error signal PERR to a low level. The level of the parity error signal PERR is settled at the timing the fourth clock cycle (parity latency—1) from time t11. After a lapse of five clock cycles since time t11, the parity latency circuit 100 outputs the internal chip select signal PCS, the internal command signal PCMD, and the internal address signal PADD. Consequently, the internal command signal ICMD3 and the internal address signal IADD3 are output, and the signals are supplied to the bank control circuit 200.

The internal command signal ICMD1 and the internal address signal IADD1 occurring at time t12 include an even number of high-level bits each. The total number of high-level bits is also an even number. Since the corresponding internal verification signal IPRTY is correctly at a low level, the verification circuit 90 deactivates the parity error signal PERR to a low level. The level of the parity error signal PERR is settled at the timing the fourth clock cycle (parity latency —1) from time t12. After a lapse of five clock cycles since time t12, the parity latency circuit 100 outputs the internal chip select signal PCS, the internal command signal PCMD, and the internal address signal PADD. Consequently, the internal command signal ICMD3 and the internal address signal IADD3 are output, and the signals are supplied to the bank control circuit 200.

Now, the internal command signal ICMD1 and the internal address signal IADD1 occurring at time t13 include an odd number of high-level bits and an even number of high-level bits, respectively. The total number of high-level bits is an odd number. In the present example, the internal verification signal IPRTY is at a low level whereas the internal verification signal IPRTY is supposed to be at a high level. The verification circuit 90 therefore activates the parity error signal PERR to a high level. The level of the parity error signal PERR is settled at the timing the fourth clock cycle (parity latency—1) from time t13. After a lapse of five clock cycles since time t13, the parity latency circuit 100 outputs the internal command signal PCMD and the internal address signal PADD. The internal chip select signal PCS is deactivated to a low level. In other words, the semiconductor device 10a enters the same state as when a DESEL command is issued. Consequently, the address latch circuit 80a and the command decoder 80b make no operation, nor is the memory cell array 11 accessed. This means that if the access A started at time t11 and the access B started at time t12 are still in process, the accesses A and B will not be stopped or changed. The accesses A and B are therefore normally executed.

The internal command signal ICMD1 and the internal address signal IADD1 occurring at time t13 are taken into the error register 130. In addition, the error processing circuit 120 generates the alert signal ALRT. The controller 50 is thus informed of the occurrence of the parity error and which command signal CMD or address signal ADD has caused the error.

After a lapse of a predetermined time since the activation of the internal verification signal IPRTY to a high level, the error processing circuit 120 activates the follow-up signal FIT. The activation of the follow-up signal FU deactivates a bank select signal BSEL to be described later, whereby the plurality of banks included in the memory cell array 11 are all deactivated.

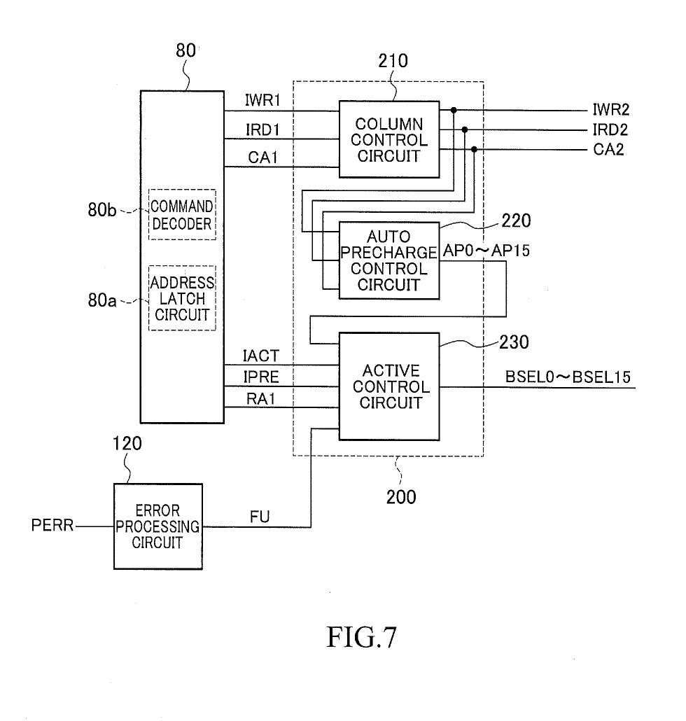

Turning to FIG. 7, the bank control circuit 200 includes a column control circuit 210, an auto precharge control circuit 220, and an active control circuit 230.

The column control circuit 210 is supplied with a write command IWR1 and a read command IRD1 from the command decoder 80b, and a column address CA1 from the address latch circuit 80a. Based on such signals, the column control circuit 210 generates a write execution signal IWR2, a read execution signal IRD2, and a column address CA2. The column control circuit 210 will be described in detail later.

The write execution signal IWR2, the read execution signal IRD2, and the column address CA2 generated by the column control circuit 210 are supplied to the auto precharge control circuit 220. Based on the signals, the auto precharge control circuit 220 generates auto precharge signals AP0 to AP15. The auto precharge signals AP0 to AP15 are signals respectively corresponding to banks B0 to 315 (to be described later) which constitute the memory cell array 11. The auto precharge control circuit 220 will be described in detail later.

The active control circuit 230 is supplied with an active command IACT and a precharge command IPRE from the command decoder 80b, and receives a row address RA1 from the address latch circuit 80a. The active control circuit 230 is also supplied with the follow-up signal FU from the error processing circuit 120. Based on such signals, the active control circuit 230 generates bank select signals BSEL0 to BSEL15. The active control circuit 230 will be described in detail later.

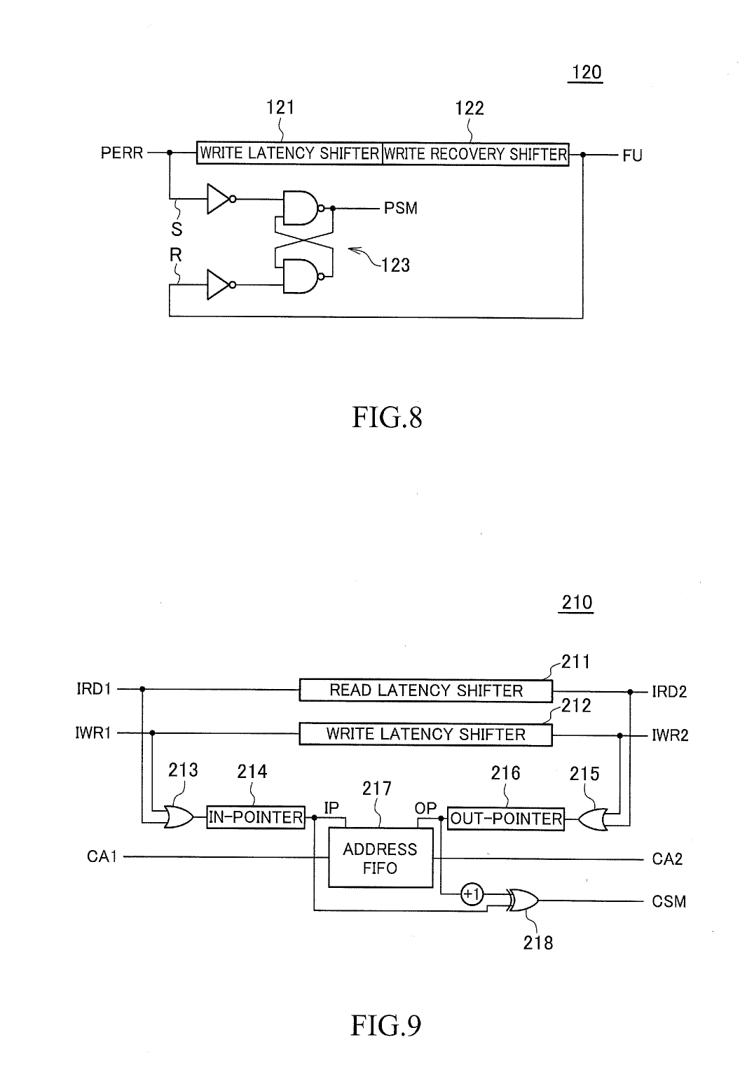

Turning to FIG. 8, the error processing circuit 120 includes a write latency shifter 121 which counts a write latency (WL) and a write recovery shifter 122 which counts a write recovery latency (WR). The write latency shifter 121 and the write recovery shifter 122 are connected in series. After the activation of the parity error signal PERR, the follow-up signal FU is activated when a first period indicated by the write latency WL and a second period indicated by the write recovery latency WR have elapsed.

The write latency WL refers to the latency from the issuance of a write command from the controller 50 to the input of the first piece of write data DQ. Issuance timing of a write command may precede its original issuance timing by an additive latency (AL). The write latency WL is thus defined by WL=AL+CWL, where latency from the original issuance timing of the write command to the input of the first piece of write data DQ is the CAS write latency (CWL).

The write recovery latency WR refers to the latency from the input of the first piece of write data DQ from the controller 50 to the proper writing of the write data DQ to memory cells MC. The write recovery latency WR is defined by WR=BL+WRa, where BL is the burst length of the write data DQ and WRa is the recovery time between when the last piece of write data DQ is input from the controller 50 and when the write data DQ is properly written to the memory cells MC.

As shown in FIG. 8, the error processing circuit 120 includes an SR latch circuit 123. The parity error signal PERR is supplied to the set terminal S of the SR latch circuit 123. The follow-up signal FU is supplied to the reset terminal R. Consequently, a parity error sequence signal PSM output from the SR latch circuit 123 is set to a high level for a period between the activation of the parity error signal PERR and the activation of the follow-up signal FU. In the present embodiment, the parity error sequence signal PSM may be referred to as a “third control signal”.

Turning to FIG. 9, the column control circuit 210 includes a read latency shifter 211 and a write latency shifter 212. The read latency shifter 211 is a circuit that receives the read command IRD1 and, after a lapse of a read latency (RL), outputs the read execution signal IRD2. The write latency shifter 212 has the same function as that of the write latency shifter 121 shown in FIG. 8. The write latency shifter 212 receives the write command IWR1 and, after a lapse of the write latency (WL), outputs the write execution signal IWR2.

The read latency RL refers to the latency from the issuance of a read command from the controller 50 to the output of the first piece of read data DQ. Issuance timing of a read command may be precede its original issuance timing by the additive latency (AL). The read latency RL is thus defined by RL=AL+CL, where latency from the original issuance timing of the read command to the output of the first piece of read data DQ is the CAS latency (CL).

The read command IRD1 and the write command IWR1 are supplied to an OR gate circuit 213. The output of the OR gate circuit 213 is supplied to an in-pointer 214, whose count value IP is thereby incremented. The count value IP of the in-pointer 214 is thus incremented each time the read command IRD1 or the write command IWR1 occurs.

Similarly, the read execution signal IRD2 and the write execution signal IWR2 are supplied to an OR gate circuit 215. The output of the OR gate circuit 215 is supplied to an out-pointer 216, whose count value OP is thereby incremented. The count value OP of the out-pointer 216 is thus incremented each time the read execution signal IRD2 or the write execution signal IWR2 occurs.

The count value IP of the in-pointer 214 and the count value OP of the out-pointer 216 are supplied to an address FIFO circuit 217. The address FIFO circuit 217 is a so-called point-shift FIFO circuit. The address FIFO circuit 217 latches an input column address CA1 into a register designated by the count value IP, and outputs a column address CA2 latched in a register designated by the count value OP. With the count value IP ahead of the count value OP by one, the column address CA1 that is supplied in synchronization with the read command IRD1 or the write command IWR1 is output as the column address CA2 in synchronization with the read execution signal IRD2 or the write execution signal IWR2.

As shown in FIG. 9, the column control circuit 210 further includes an XOR gate circuit 218. The count value IP and the value of the count value OP plus one are supplied to the XOR gate circuit 218. If the two values do not coincide with each other, the XOR gate circuit 218 activates a column sequence signal CSM to a high level. In the present embodiment, the column sequence signal CMS may be referred to as a “first control signal”. The XOR gate circuit 218 may be referred to as a “first comparison circuit”.

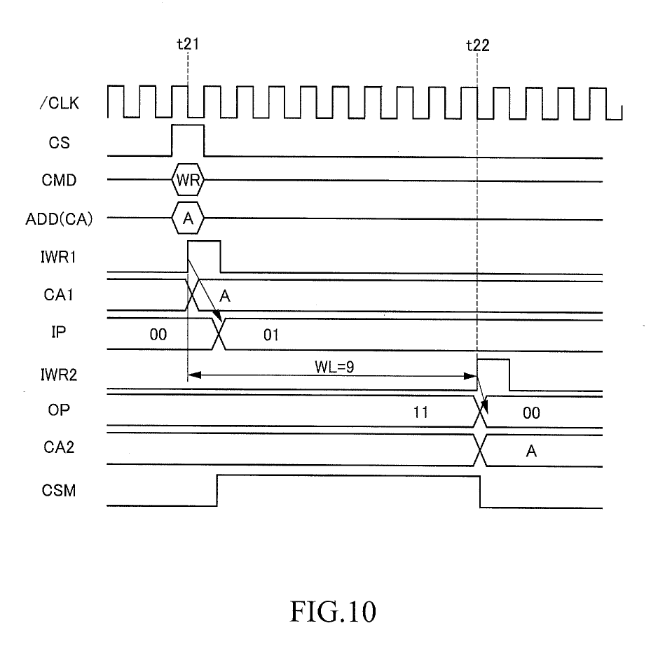

Turning to FIG. 10, in this example, the chip select signal CS is activated and a write command WR is issued at time t21. In the state before time t21, the in-pointer 214 has a count value IP of “00” and the out-pointer 216 has a count value OP of “11”. The XOR gate circuit 218 thus maintains the column sequence signal CSM at a low level. This means that no command is retained in the read latency shifter 211 or the write latency shifter 212.

When the write command WR and the column address CA are input from the controller 50 at time t21, the command decoder 80b outputs the write command IWR1 to the column control circuit 210. The address latch circuit 80a outputs the column address CA1 to the column control circuit 210. In response to the activation of the write command IWR1, the count value IP of the in-pointer 214 is incremented to “01”. Consequently, the XOR gate circuit 218 activates the column sequence signal CSM to a high level. This means that one or more commands are retained in the read latency shifter 211 or the write latency shifter 212.

After a lapse of nine clock cycles (time t22) since the issuance of the write command WR, the write latency shifter 212 outputs the write execution signal IWR2. In response, the count value OP of the out-pointer 216 is incremented to “00”. Consequently, the XOR gate circuit 218 deactivates the column sequence signal CSM to a low level.

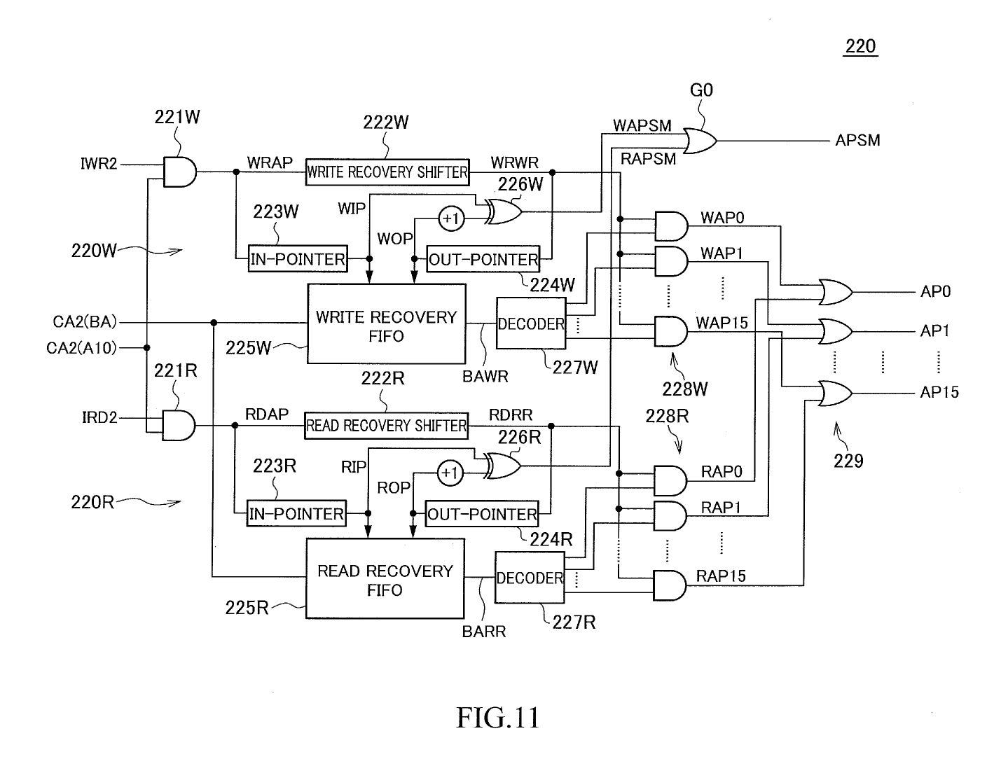

Turning to FIG. 11, the auto precharge control circuit 220 includes a write-operation control circuit 220W and a read-operation control circuit 220R.

The write-operation control circuit 220W includes an AND gate circuit 221W and a write recovery shifter 222W. The AND gate circuit 221W receives the write execution signal IWR2 and an auto precharge specification signal CA2 (A10). The write recovery shifter 222W receives an auto precharge signal WRAP output from the AND gate circuit 221W. The auto precharge specification signal CA2 (A10) is a signal that is supplied through a predetermined address terminal (A10 pin) when a read command or write command is issued. If the auto precharge specification signal CA2 (A10) is set to a high level upon the issuance of a read command or write command, a precharge operation is automatically performed after the end of the read operation or write operation.

The write recovery shifter 222W has the same function as that of the write recovery shifter 122 shown in FIG. 8. More specifically, the write recovery shifter 222W receives the auto precharge signal WRAP and, after a lapse of the write recovery latency (WR), outputs a write recovery completion signal WRWR.

The auto precharge signal WRAP is also supplied to an in-pointer 223W, whose count value WIP is thereby incremented. The count value WIP of the in-pointer 223W is thus incremented each time the auto precharge signal WRAP occurs. Similarly, the write recovery completion signal WRWR is supplied to an out-pointer 224W, whose count value WOP is thereby incremented. The count value WOP of the out-pointer 224W is thus incremented each time the write recovery completion signal WRWR occurs.

The count value WIP of the in-pointer 223W and the count value WOP of the out-pointer 224W are supplied to a write recovery FIFO circuit 225W. The write recovery FIFO circuit 225W is a so-called point-shift FIFO circuit. The write recovery FIFO circuit 225W latches the input bank address CA2 (BA) into a register designated by the count value WIP, and outputs a bank address BAWR latched in a register designated by the count value WOP. With the count value WIP ahead of the count value WOP by one, the bank address CA2 (BA) that is supplied in synchronization with the auto precharge signal WRAP is output as the bank address BAWR in synchronization with the write recovery completion signal WRWR.

As shown in FIG. 11, the write-operation control circuit 220W further includes an XOR gate circuit 226W. The count value WIP and the value of the count value WOP plus one are supplied to the XOR gate circuit 226W. If the two values do not coincide with each other, the XOR gate circuit 226W activates a sequence signal WAPSM to a high level. The XOR gate circuit 226W may be referred to as a “second comparison circuit”.

The bank address BAWR output from the write recovery FIFO circuit 225W is supplied to a decoder 227W. The decoder 227W decodes the bank address BAWR to select any one of 16 AND gate circuits 228W which are provided for the respective banks. The write recovery completion signal WRWR is supplied to the other input nodes of the AND gate circuits 228W. The outputs of the AND gate circuits 228W are input to either one of the input nodes of respective corresponding OR gate circuits 229.

The read-operation control circuit 220R has the same circuit configuration as that of the write-operation control circuit 220W. To be more specific, the read-operation control circuit 220R includes an AND gate circuit 221R and a read recovery shifter 222R. The AND gate circuit 221R receives the read execution signal IRD2 and the auto precharge specification signal CA2 (A10). The read recovery shifter 222R receives an auto precharge signal RDAP output from the AND gate circuit 221R.

The read recovery shifter 222R is a circuit that counts a read recovery latency (RR). The read recovery latency RR refers to latency that is needed to restore read-out read data DQ to memory cells MC after the output of the read data DQ is started. The read recovery latency RR is defined by RR=BL+RRa, where BL is the burst length of the read data DQ and RRa is the recovery time from the output of the last piece of read data DQ to the restoration of the read data DQ to the memory cells MC. The read recovery shifter 222R thus outputs a read recovery completion signal RDRR after a lapse of the read recovery latency (RR) since the input of the auto precharge signal RDAP.

The auto precharge signal RDAP is also supplied to an in-pointer 223R, whose count value RIP is thereby incremented. The count value RIP of the in-pointer 223R is thus incremented each time the auto precharge signal RDAP occurs. Similarly, the read recovery completion signal RDRR is supplied to an out-pointer 224R, whose count value ROP is thereby incremented. The count value ROP of the out-pointer 224R is thus incremented each time the read recovery completion signal RDRR occurs.

The count value RIP of the in-pointer 223R and the count value ROP of the out-pointer 224R are supplied to a read recovery FIFO circuit 225R. The read recovery FIFO circuit 225R is a so-called point-shift FIFO circuit. The read recovery FIFO circuit 225R latches the input bank address CA2 (BA) into a register designated by the count value RIP, and outputs a bank address BARR latched in a register designated by the count value ROP. With the count value RIP ahead of the count value ROP by one, the bank address CA2 (BA) that is supplied in synchronization with the auto precharge signal RDAP is output as the bank address BARR in synchronization with the read recovery completion signal RDRR.

The read-operation control circuit 220R further includes an XOR gate circuit 226R. The count value RIP and the value of the count value ROP plus one are supplied to the XOR gate circuit 226R. If the two values do not coincide with each other, the XOR gate circuit 226R activates a sequence signal RAPSM to a high level.

The bank address BARR output from the read recovery FIFO circuit 225R is supplied to a decoder 227R. The decoder 227R decodes the bank address BARR to select any one of 16 AND gate circuits 228R which are provided for the respective banks. The read recovery completion signal RDRR is supplied to the other input nodes of the AND gate circuits 228R. The outputs of the AND gate circuits 228R are input to the other input nodes of the respective corresponding OR gate circuits 229.

The OR gate circuits 229 are provided for the respective banks, and generate the respective auto precharge signals AP0 to AP15. The auto precharge signals AP0 to AP15 are supplied to the active control circuit 230 to be described later. The auto precharge signals AP0 to AP15 are used to control auto precharge operations in the respective banks. The sequence signal WAPSM and the sequence signal RAPSM are supplied to an OR gate circuit G0. The output of the OR gate circuit G0 is output as an auto precharge sequence signal APSM. In the present embodiment, the auto precharge sequence signal APSM may be referred to as a “second control signal”.

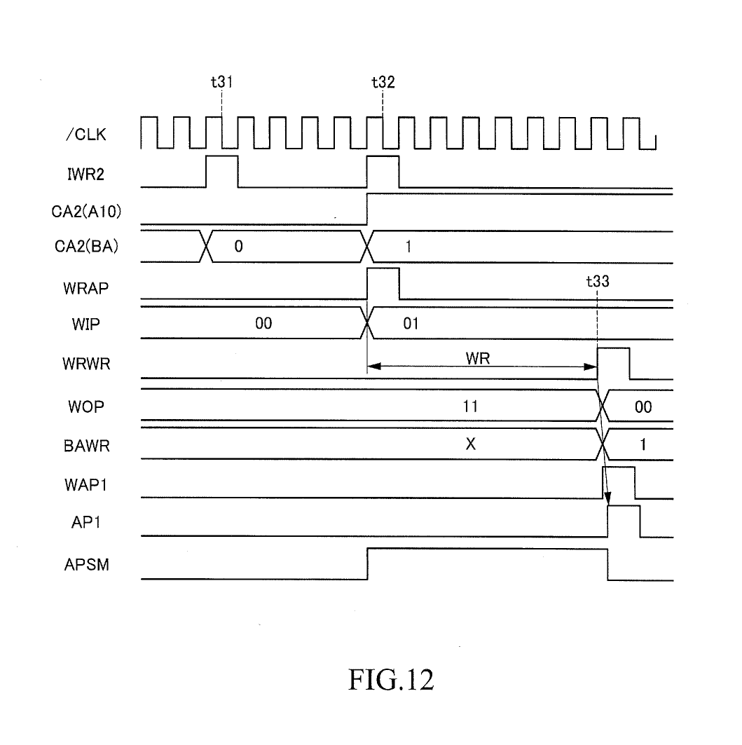

Turning to FIG. 12, in this example, the write execution signal IWR2 occurs at times t31 and t32. For the write execution signal IWR2 occurring at time t31, the auto precharge specification signal CA2 (A10) is set to a low level. For the write execution signal IWR2 occurring at time t32, the auto precharge specification signal CA2 (A10) is set to a high level. In the state before time t31, the in-pointer 223W has a count value WIP of “00” and the out-pointer 224W has a count value WOP of “11”. The auto precharge sequence signal APSM is thus at a low level. This means that no command is retained in the write recovery shifter 222W (or the read recovery shifter 222R).

In the example shown in FIG. 12, when the write execution signal IWR2 occurs at time t31, the auto precharge signal WRAP is not activated since the auto precharge specification signal CA2 (A10) here is set to a low level. The auto precharge control circuit 220 therefore ignores the access.

When the write execution signal IWR2 occurs at time t32, the auto precharge specification signal CA2 (A10) is set to a high level. This activates the auto precharge signal WRAP to a high level, which is input to the write recovery shifter 222W. In response to the activation of the auto precharge signal WRAP, the count value WIP of the in-pointer 223W is incremented to “01”. Consequently, the OR gate circuit G0 activates the auto precharge sequence signal APSM to a high level. This means that one or more commands are retained in the write recovery FIFO circuit 225W or the read recovery FIFO circuit 225R.

After a lapse of the write recovery latency WR since the activation of the auto precharge signal WRAP, the write recovery shifter 222W outputs the write recovery completion signal WRWR (time t33). In response, the count value WOP of the out-pointer 224W is incremented to “00”. Consequently, the OR gate circuit G0 deactivates the auto precharge sequence signal APSM to a low level. The write recovery FIFO circuit 225W outputs the bank address CA2 (BA) supplied at time t32 as the bank address BAWR. In the example shown in FIG. 12, the bank address CA2 (BA) supplied at time t32 has a value of “1”. The auto precharge signal AP1 corresponding to bank 1 is thus activated.

The foregoing operation is based on the activation of the write execution signal IWR2. The same holds for the case where the read execution signal IRD2 is activated.

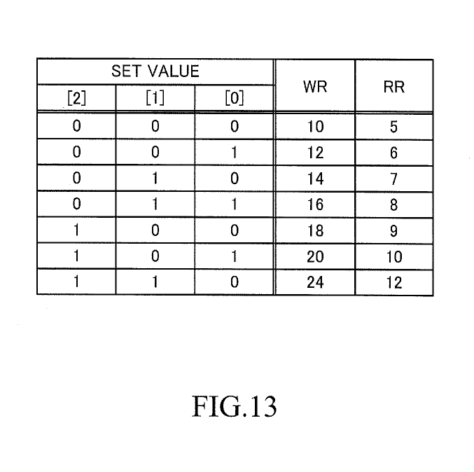

It should be noted that the latency of the write recovery shifter 222W (write recovery latency WR) and the latency of the read recovery shifter 222R (read recovery latency RR) need not be fixed in value and may be variable depending on a set value of the mode register 25. Turning to FIG. 13, in this example, three bits [0] to [2] of the mode register 25 are used to switch the write recovery latency WR and the read recovery latency RR in seven levels each. It will be understood that the other latencies (AL, CL, and CWL) and the burst length (BL) can also be changed depending on a set value of the mode register 25.

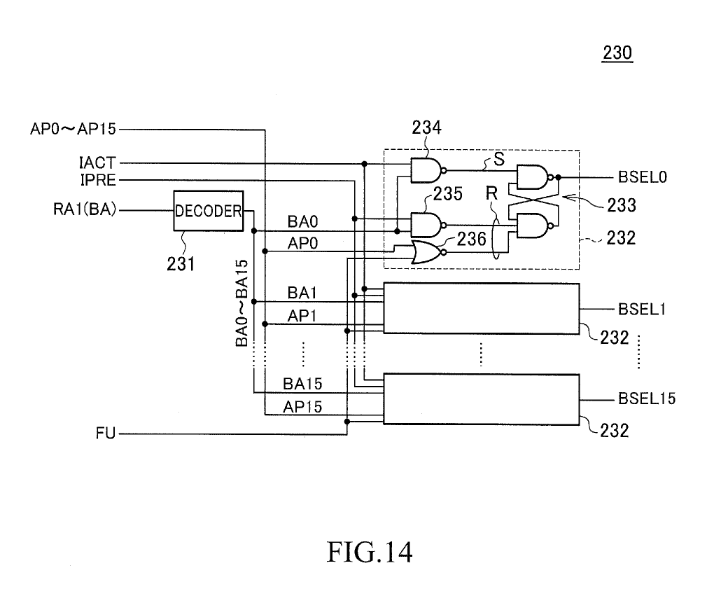

Turning to FIG. 14, the active control circuit 230 includes a decoder 231 which decodes the row address RA1 (BA) and control circuits 232 which are provided for the respective banks. The decoder 231 decodes the bank address included in the row address RA1 to activate anyone of bank select signals BA0 to BA15. The bank select signals BA0 to BA15 are supplied to the respective corresponding control circuits 232.

The control circuits 232 each include an SR latch circuit 233. The output of a NAND gate circuit 234 is supplied to the set terminal S of the SR latch circuit 233. The active command IACT and a corresponding one of the bank select signals BA0 to BA15 are supplied to the NAND gate circuit 234. When the active command IACT is activated, the SR latch circuit 233 in the control circuit 232 selected by the bank address is set. If the SR latch circuit 233 is set, the corresponding one of the bank select signals BSEL0 to BSEL15 is activated to a high level.

The output of a NAND gate circuit 235 is supplied to the reset terminal R of the SR latch circuit 233. The precharge command IPRE and a corresponding one of the bank select signals BA0 to BA15 are supplied to the NAND gate circuit 235. When the precharge command IPRE is activated, the SR latch circuit 233 in the control circuit 232 selected by the bank address is reset. If the SR latch circuit 233 is reset, the corresponding one of the bank select signals BSEL0 to BSEL15 is deactivated to a low level.

The output of a NOR gate circuit 236 is also supplied to the reset terminal R of the SR latch circuit 233. The follow-up signal FU and a corresponding one of the auto precharge signals AP0 to AP15 are supplied to the NOR gate circuit 236. When the auto precharge signals AP0 to AP15 are activated, the SR latch circuits 233 in the corresponding control circuits 232 are reset. When the follow-up signal FU is activated, the SR latch circuits 233 in all the control circuits 232 are reset regardless of the auto precharge signals AP0 to AP15. That is, if the follow-up signal FU is activated, all the bank select signals BSEL0 to BSEL15 are forcefully deactivated to a low level.

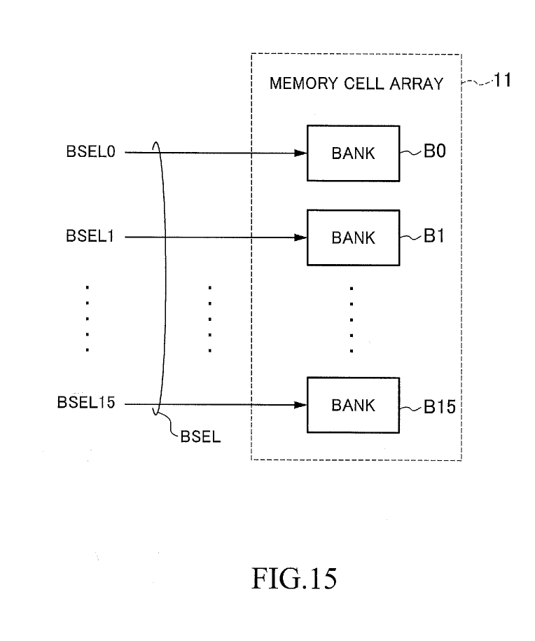

Turning to FIG. 15, the bank select signals BSEL0 to BSEL15 are supplied to the respective corresponding banks B0 to B15. The banks B0 to B15 are the units of division of the memory cell array 11 shown in FIG. 1. The banks B0 to B15 can be accessed by the access control circuit 20 in a mutually non-exclusive manner. With such a configuration, when an active command IACT is issued, any one of the bank select signals BSEL0 to BSEL15 changes from a low level to a high level to activate the corresponding one of the banks B0 to B15. When a precharge command IPRE is issued, any one of the bank select signals BSEL0 to BSEL15 changes from a high level to a low level to deactivate the corresponding one of the banks B0 to B15.

The auto precharge specification signal CA (A10) may be set to a high level when a write command IWR1 or read command IRD1 is issued. In such a case, after a lapse of the write recovery latency WR or the read recovery latency RR since the completion of the write operation or read operation, the one of the bank select signals BSEL0 to BSEL15 corresponding to that bank changes from a high level to a low level.

In addition, if the address signal ADD or command signal CMD supplied from the controller 50 is erroneous, all the bank select signals BSEL0 to BSEL15 are set to a low level by the control of the error processing circuit 120 after a lapse of the write latency WL and the write recovery latency WR. All the banks B0 to B15 are thereby deactivated into a precharge state.

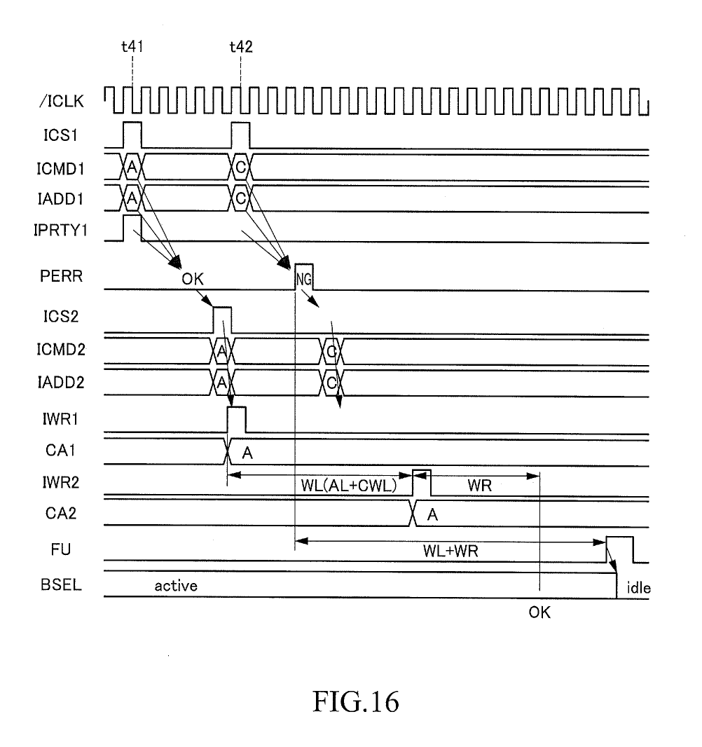

Turning to FIG. 16, in this example, the internal chip select signal ICS1, the internal command signal ICMD1, and the internal address signal IADD1 occur at times t41 and t42.

Suppose that the internal command signal ICMD1 and the internal address signal IADD1 occurring at time t41 include an odd number of high-level bits and an even number of high-level bits, respectively. The total number of high-level bits is an odd number. Since the corresponding internal verification signal IPRTY is correctly at a high level, the verification circuit 90 deactivates the parity error signal PERR to a low level. As a result, the processing based on the command is properly performed. Specifically, after a lapse of the parity latency since time t41, the internal chip select signal ICS2 is activated and the internal command signal ICMD2 and the internal address signal IADD2 are output. In response to this, the write command IWR1 is activated, and a write operation is performed on the bank specified by the internal address signal IADD2. In fact, the input of write data DQ is started after a lapse of the write latency WL since the activation of the write command IWR1. The writing of the data to memory cells MC is completed after a lapse of the write recovery latency WR.

Now, the internal command signal ICMD1 and the internal address signal IADD1 occurring at time t42 include an odd number of high-level bits and an even number of high-level bits, respectively. In the present example, the internal verification signal IPRTY is at a low level whereas the internal verification signal IPRTY is supposed to be at a high level. The verification circuit 90 therefore activates the parity error signal PERR to a high level. As has been described, the high level of the parity error signal PERR fixes the internal chip select signal ICS2 to a low level. No access is thus made to the memory cell array 11.

Instead, after a lapse of the write latency WL and the write recovery latency WR since the activation of the parity error signal PERR, the error processing circuit 120 generates the follow-up signal FU. In response, all the SR latch circuits 233 included in the active control circuit 230 are reset to precharge all the banks B0 to B15.

At the activation timing of the follow-up signal FU, it is guaranteed that all operations based on the previous command have been completed. The reason is that the maximum time (including recovery time) needed for a DRAM to complete operation after the issuance of a column system command (read command RD or write command WR) is defined by the total time of the write latency WL and the write recovery latency WR. In other words, the operation based on the previous command is considered to be completed after await for the total time of the write latency WL and the write recovery latency WR since the issuance of the command. All the banks can thus be deactivated without affecting the operation based on the previous command.

As described above, according to the present embodiment, when the parity error PERR is activated, the follow-up signal FU is activated after a lapse of the write latency WL and the write recovery latency WR. All the banks can thus be deactivated after the processing based on the command issued before is properly completed.

Note that the foregoing embodiment is predicated on that the maximum time needed to complete operation after the issuance of a column system command is the same as the total time of the write latency WL and the write recovery latency WR. If the maximum time needed to complete operation after the issuance of a column system command is different to the above, the configuration of the error processing circuit 120 may be modified accordingly. For example, suppose the maximum time needed to complete operation after the issuance of a column system command is defined by the total time of the read latency RL and the read recovery latency RR. Such a semiconductor memory device may use a read latency shifter that counts the read latency RL and a read recovery shifter that counts the read recovery latency RR instead of the write latency shifter 121 and the write recovery shifter 122 shown in FIG. 8.

Next, a second embodiment of the present invention will be described.

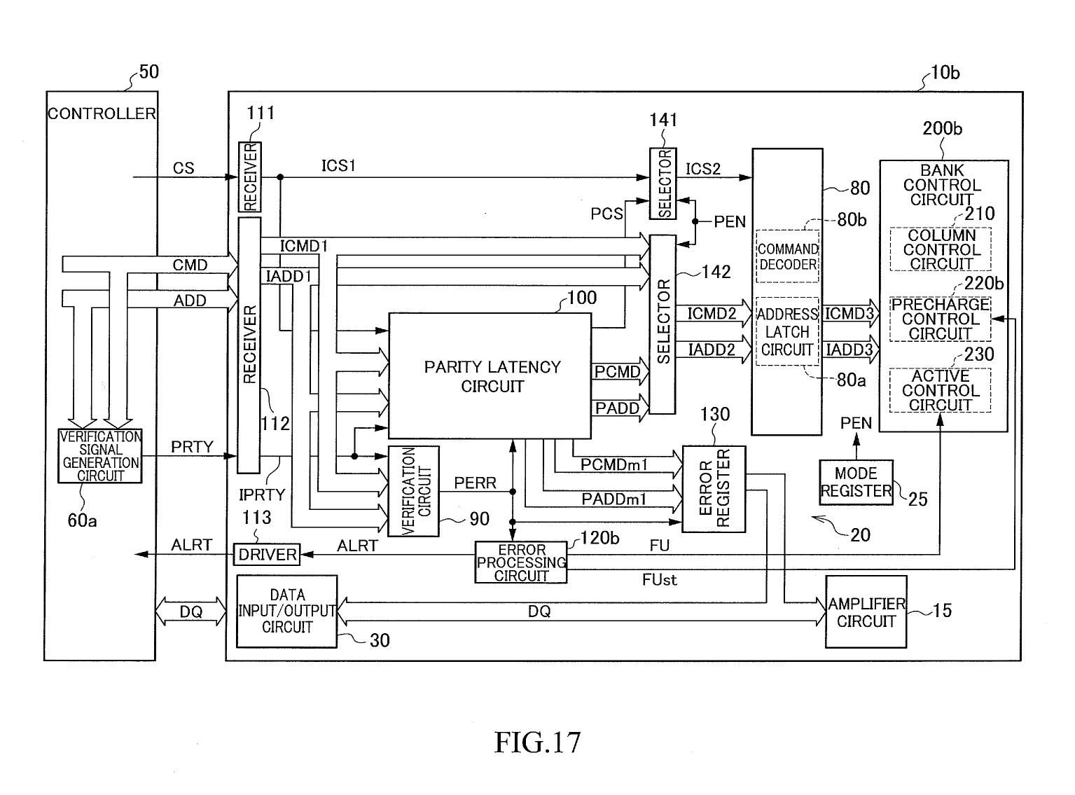

Turning to FIG. 17, the semiconductor device 10b according to the present embodiment differs from the semiconductor device 10a according to the first embodiment in that an error processing circuit 120b replaces the error processing circuit 120 and a bank control circuit 200b replaces the bank control circuit 200. In other respects, the semiconductor device 10b is the same as the semiconductor device 10a according to the first embodiment. The same components will thus be designated by like reference numerals. Redundant description will be omitted.

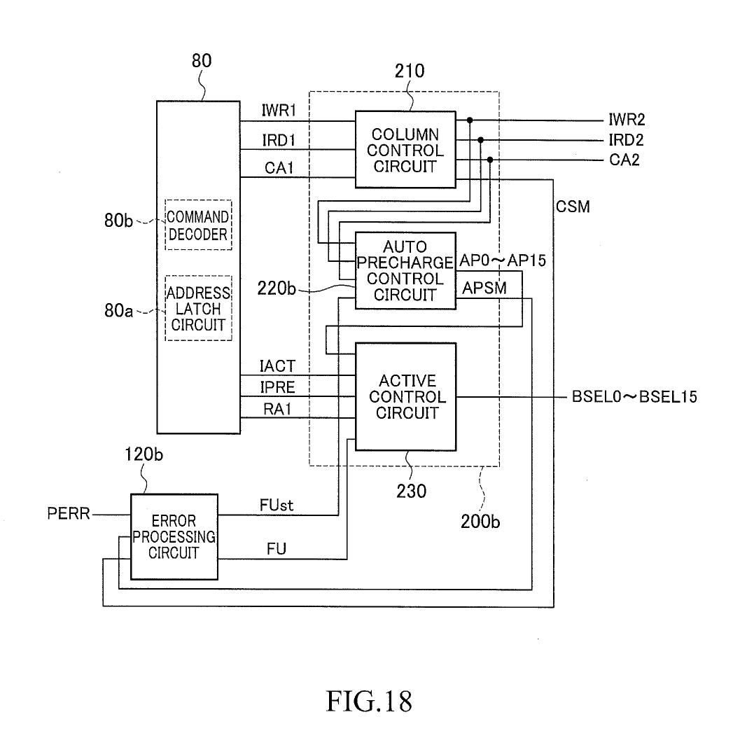

Turning to FIG. 18, the bank control circuit 200b includes the column control circuit 210, an auto precharge control circuit 220b, and the active control circuit 230. The column control circuit 210 and the active control circuit 230 have the same circuit configuration as has been described.

The auto precharge control circuit 220b is supplied with the write execution signal IWR2, the read execution signal IRD2, the column address CA2, and a follow-up start signal FUst. The follow-up start signal FUst is a signal generated by the error processing circuit 120b. In the present embodiment, the follow-up start signal FUst may be referred to as a “fourth control signal”. Based on such signals, the auto precharge control circuit 220b generates auto precharge signals AP0 to AP15 and an auto precharge sequence signal APSM. The auto precharge sequence signal APSM is supplied to the error processing circuit 120b along with the column sequence signal CSM.

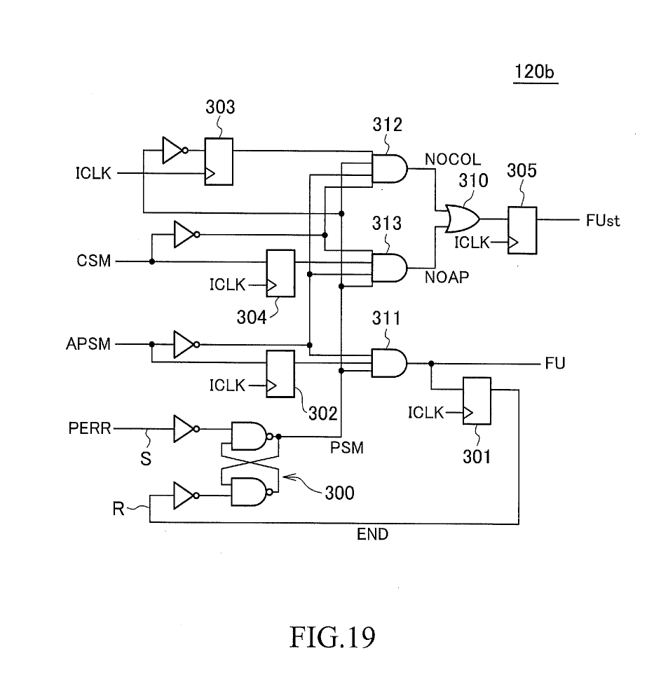

Turning to FIG. 19, the error processing circuit 120b includes an SR latch circuit 300. The parity error signal PERR is supplied to the set terminal S of the SR latch circuit 300. An end signal END, which is the follow-up signal FU synchronized with the internal clock signal ICLK, is supplied to the reset terminal R. As a result, a parity error sequence signal PSM output from the SR latch circuit 300 is set to a high level for a period between when the parity error signal PERR is activated and when the activated follow-up signal FU is taken into a latch circuit 301. The parity error sequence signal PSM is supplied to AND gate circuits 311 to 313.

Aside from the parity error sequence signal PSM, the input nodes of the AND gate circuit 311 are supplied with the inverted signal of the auto precharge sequence signal APSM and the output signal of a latch circuit 302 which takes in the auto precharge sequence signal APSM. The output of the AND gate circuit 311 is used as the follow-up signal FU, which is supplied to the active control circuit 230. By such a configuration, when the auto precharge sequence signal APSM changes from a high level to a low level with the parity error sequence signal PSM activated to a high level, the follow-up signal FU is activated to a high level for only one clock cycle. In the present embodiment, the AND gate circuit 311 may be referred to as a “first logic gate circuit”.

The input nodes of the AND gate circuit 312 are supplied with the output signal of a latch circuit 303, the inverted signal of the column sequence signal CSM, and the inverted signal of the auto precharge sequence signal APSM aside from the parity error sequence signal PSM. The latch circuit 303 takes in the inverted signal of the parity error signal PSM. The output of the AND gate circuit 312 is used as a column access detection signal NOCOL, which is supplied to the latch circuit 305 through an OR gate circuit 310. The output of the latch circuit 305 is used as the follow-up start signal FUst, which is supplied to the active control circuit 230. By such a configuration, when the parity error sequence signal PSM is activated to a high level with both the column sequence signal CMS and the auto precharge sequence signal APSM deactivated to a low level, the follow-up start signal FUst is activated to a high level for only one clock cycle in synchronization with the internal clock signal ICLK.

The input nodes of the AND gate circuit 313 are supplied with the inverted signal of the column sequence signal CSM, the output signal of a latch circuit 304, and the inverted signal of the auto precharge sequence signal APSM aside from the parity error sequence signal PSM. The latch circuit 304 takes in the column sequence signal CSM. The output of the AND gate circuit 313 is used as an auto precharge detection signal NOAP, which is supplied to the latch circuit 305 through the OR gate circuit 310. As described above, the output of the latch circuit 305 is used as the follow-up start signal FUst. By such a configuration, when the column sequence signal CSM changes from a high level to a low level with the auto precharge sequence signal APSM deactivated to a low level and the parity error sequence signal PSM activated to a high level, the follow-up start signal FUst is activated to a high level for only one clock cycle.

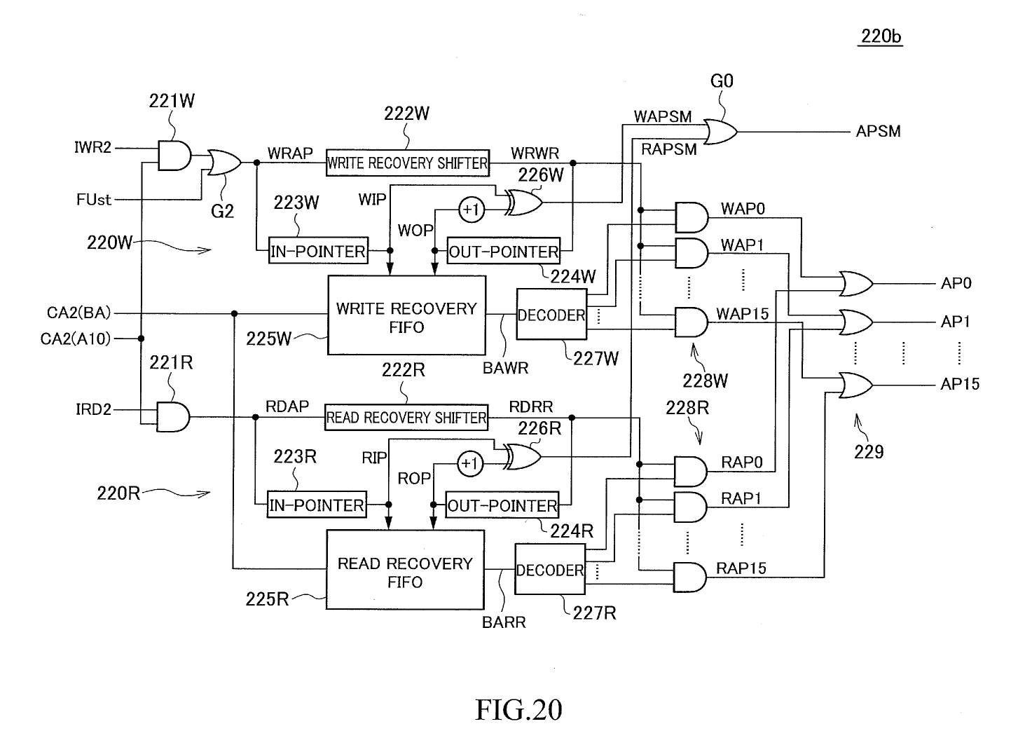

Turning to FIG. 20, the auto precharge control circuit 220b differs from the auto precharge control circuit 220 shown in FIG. 11 in that there is an additional OR gate circuit G2. In other respects, the auto precharge control circuit 220b is the same as the auto precharge control circuit 220. The same components will thus be designated by like reference numerals. Redundant description will be omitted.

The output of the AND gate circuit 221W is input to one of the input nodes of the OR gate circuit G2. The follow-up start signal FUst is supplied to the other input node. The output of the OR gate G2 is used as the auto precharge signal WRAP. With such a configuration, when the follow-up start signal FUst is activated, the write recovery shifter 222W performs an operation for counting the write recovery latency WR regardless of the write execution signal IWR2.

Next, the operation of the semiconductor device 10b according to the present embodiment will be described.

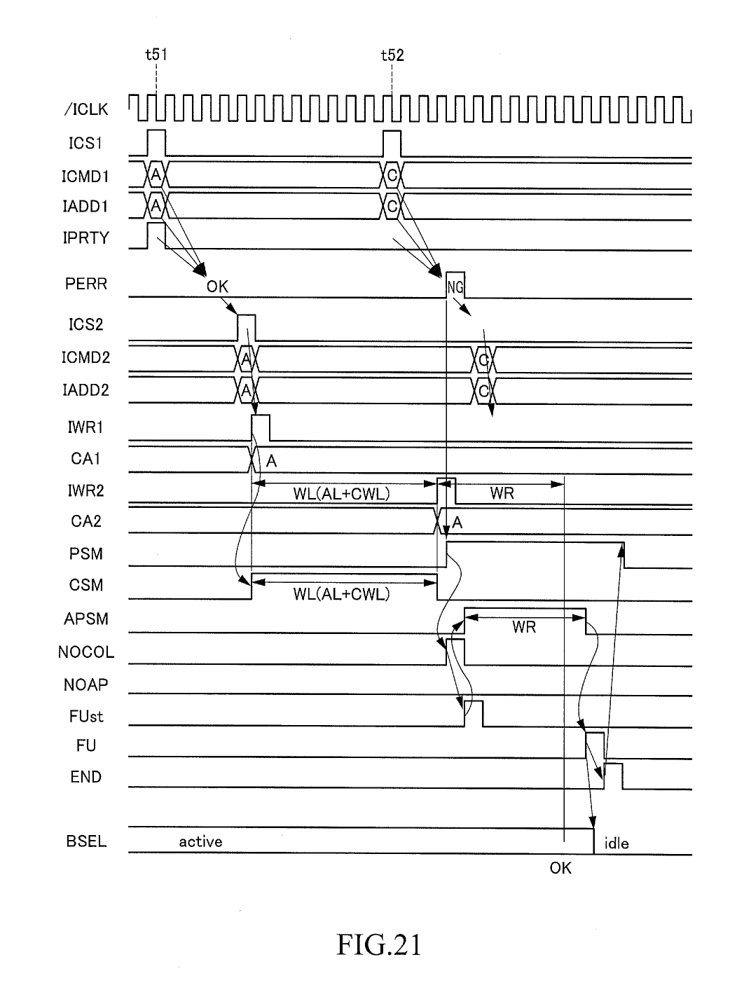

Turning to FIG. 21, in this example, the internal chip select signal ICS1, the internal command signal ICMD1, and the internal address signal IADD1 occur at times t51 and t52.

Suppose that the internal command signal ICMD1 and the internal address signal IADD1 occurring at time t51 include an odd number of high-level bits and an even number of high-level bits, respectively. The total number of high-level bits is an odd number. Since the corresponding internal verification signal IPRTY is correctly at a high level, the verification circuit 90 deactivates the parity error signal PERR to a low level. As a result, the processing based on the command is properly performed. Specifically, after a lapse of the parity latency since time t51, the internal chip select signal ICS2 is activated and the internal command signal ICMD2 and the internal address signal IADD2 are output. In response to this, the write command IWR1 is activated, and a write operation is performed on the bank specified by the internal address signal IADD2. In fact, the input of write data DQ is started after a lapse of the write latency WL since the activation of the write command IWR1. The writing of the data to memory cells MC is completed after a lapse of the write recovery latency WR.

In the example shown in FIG. 21, a write access is requested again at time t52 when the foregoing write operation is still in process. Suppose that the internal command signal ICMD1 and the internal address signal IADD1 occurring at time t52 include an odd number of high-level bits and an even number of high-level bits, respectively. In the present example, the internal verification signal IPRTY is at a low level whereas the internal verification signal IPRTY is supposed to be at a high level. The verification circuit 90 therefore activates the parity error signal PERR to a high level. As has been described, the high level of the parity error signal PERR fixes the internal chip select signal ICS2 to a low level. No access is thus made to the memory cell array 11.

The activation of the parity error signal PERR activates the parity error sequence signal PSM to a high level. In the present example, both the column sequence signal CSM and the auto precharge sequence signal APSM are deactivated to a low level at the timing when the parity error sequence signal PSM is activated to a high level. This means that at the timing of the occurrence of the parity error, no command is retained in the column control circuit 210, nor is any auto precharge signal retained in the auto precharge control circuit 220b.

Consequently, the output of the AND gate circuit 312 shown in FIG. 19, or the column access detection signal NOCOL, is activated to a high level. The follow-up start signal FUst is activated to a high level in synchronization with the internal clock signal ICLK. The follow-up start signal FUst is supplied to the write recovery shifter 222W through the OR gate circuit G2 shown in FIG. 20, whereby the operation for counting the write recovery latency WR is performed. During the period when such a count operation is in process, the auto precharge sequence signal APSM is activated to a high level.

After a lapse of the write recovery latency WR, the auto precharge sequence signal APSM is deactivated to a low level. In response, the AND gate circuit 311 shown in FIG. 19 outputs the follow-up signal FU, whereby all the banks B0 to B15 are precharged. Subsequently, the end signal END is activated in synchronization with the internal clock signal ICLK, whereby the SR latch circuit 300 is reset. This restores the parity error sequence signal PSM to a low level.

As described above, if a parity error occurs when the column control circuit 210 is at rest, all the banks B0 to B15 are precharged after a lapse of the write recovery latency WR since the occurrence of the parity error. The reason is that a write recovery operation based on a write command issued immediately before may be in operation even if the parity error occurs when the column control circuit 210 is at rest. FIG. 21 shows such a case. In view of the foregoing, according to the present embodiment, all the banks B0 to B15 are not immediately precharged but after a lapse of the write recovery latency WR even if a parity error occurs when the column control circuit 210 is at rest. All the banks can thus be deactivated in such a state that the processing based on the commands issued before is guaranteed to have been properly completed.

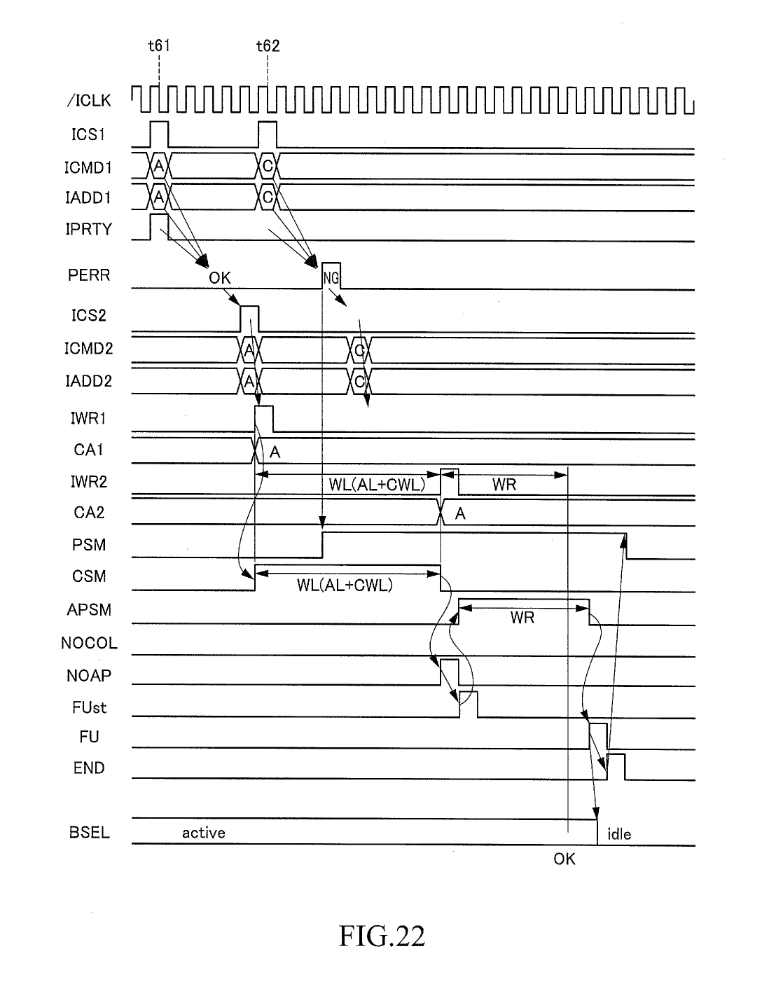

Turning to FIG. 22, in this example, the internal chip select signal ICS1, the internal command signal ICMD1, and the internal address signal IADD1 occur at times t61 and t62.

The operations based on the internal command signal ICMD1 and the internal address signal IADD1 occurring at time t61 are the same as those corresponding to time t51 shown in FIG. 21. In this example, the next command is submitted at earlier timing (time t62) than in the example shown in FIG. 21. The command corresponding to time t61 is thus still retained in the column control circuit 210 at the point in time when the parity error signal PERR is activated. In this example, the column sequence signal CSM is activated to a high level when the parity error signal PERR is activated. The follow-up start signal FUst therefore will not be immediately activated even if the parity error sequence signal PSM is activated to a high level.

Subsequently, when the write execution signal IWR2 corresponding to the command retained in the column control circuit 210 is output, the column sequence signal CSM changes to a low level. In response, the output of the AND gate circuit 313 shown in FIG. 19, or the auto precharge detection signal NOAP, is activated to a high level. The follow-up start signal FUst is activated to a high level in synchronization with the internal clock signal ICLK. The follow-up start signal FUst is supplied to the write recovery shifter 222W through the OR gate circuit G2 shown in FIG. 20, whereby the operation for counting the write recovery latency WR is performed. During the period when such a count operation is in process, the auto precharge sequence signal APSM is activated to a high level.

After a lapse of the write recovery latency WR, the auto precharge sequence signal APSM is deactivated to a low level. In response, the AND gate circuit 311 shown in FIG. 19 outputs the follow-up signal FU, whereby all the banks B0 to B15 are precharged. Subsequently, the end signal END is activated in synchronization with the internal clock signal ICLK, whereby the SR latch circuit 300 is reset. This restores the parity error sequence signal PSM to a low level.

As described above, if a parity error occurs when the column control circuit 210 is in operation, all the banks B0 to B15 are precharged after a lapse of the write recovery latency WR since the change of the column sequence signal CMS to a low level. All the banks B0 to B15 are thereby precharged after a lapse of the write recovery latency WR since the execution of all column system commands issued immediately before. All the banks can thus be deactivated in a state such that the processing based on the commands issued before is guaranteed to have been properly completed.

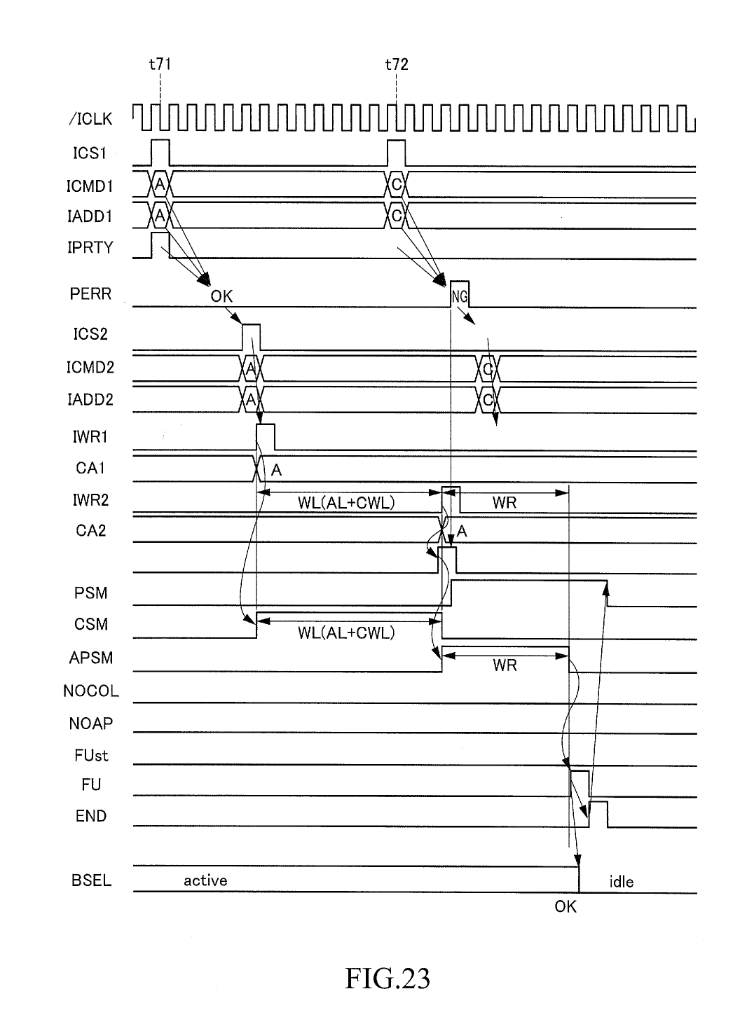

Turning to FIG. 23, in this example, the internal chip select signal ICS1, the internal command signal ICMD1, and the internal address signal IADD1 occur at times t71 and t72.

The operations based on the internal command signal ICMD1 and the internal address signal IADD1 occurring at time t71 are basically the same as those corresponding to time t51 shown in FIG. 21. In this example, the write command occurring at time t71 includes an auto precharge. After the change of the column sequence signal CSM to a low level, the auto precharge sequence signal APSM is thus activated to a high level. In the example shown in FIG. 23, the auto precharge sequence signal APSM is still activated to a high level by such a series of operations when a parity error occurs. The follow-up start signal FUst therefore will not be activated even if the parity error sequence signal PSM is activated to a high level.

Subsequently, when the auto precharge signal WRAP retained in the write recovery shifter 222W is output, the auto precharge sequence signal APSM changes to a low level. In response, the AND gate circuit 311 shown in FIG. 19 outputs the follow-up signal FU, whereby all the banks B0 to B15 are precharged. The end signal END is then activated in synchronization with the internal clock signal ICLK, whereby the SR latch circuit 300 is reset. This restores the parity error sequence signal PSM to a low level.

As described above, if a parity error occurs when the auto precharge control circuit 220b is in operation, all the banks B0 to B15 are precharged after a wait for the auto precharge sequence signal APSM to change to a low level. As a result, all the banks B0 to B15 are precharged after the auto precharge operation based on the column system command issued immediately before is executed. In other words, all the banks can be deactivated in such a state that the processing based on commands issued before is guaranteed to have been properly completed.

As has been described, according to the present embodiment, when a parity error occurs, all the banks are deactivated in response to the proper completion of processing based on the command issued immediately before. All the banks can thus be deactivated earlier than in the case of unconditionally waiting for a lapse of a certain period like the first embodiment. In addition, the error processing circuit 120b used in the present embodiment is in no need of the write latency shifter 121 or the write recovery shifter 122 which have a large circuit scale. This even allows a reduction in the occupied area on the chip.

It is apparent that the present invention is not limited to the above embodiments, but may be modified and changed without departing from the scope and spirit of the invention.

For example, the foregoing embodiments have dealt with the cases of verifying the entire logic of the command signal CMD and the address signal ADD. However, the present invention is not limited thereto. The logic of only the command signal CMD may be verified. The logic of only the address signal ADD may be verified.

Volatile memories, non-volatile memories, or mixtures of them can be applied to the memory cells of the present invention.

The technical concept of the present invention is not limited to a semiconductor device including memory cells, and may be applied to a semiconductor device including a signal transmission circuit. The forms of the circuits in the circuit blocks disclosed in the drawings and other circuits for generating the control signals are not limited to the circuit forms disclosed in the embodiments.

When the transistors are field effect transistors (FETs), various FETs are applicable, including MIS (Metal Insulator Semiconductor) and TFT (Thin Film Transistor) as well as MOS (Metal Oxide Semiconductor). The device may even include bipolar transistors. For example, the present invention can be applied to a general semiconductor device such as a CPU (Central Processing Unit), an MCU (Micro Control Unit), a DSP (Digital Signal Processor), an ASIC (Application Specific Integrated Circuit), and an ASSP (Application Specific Standard Circuit), each of which includes a memory function. An SOC (System on Chip), an MCP (Multi Chip Package), and a POP (Package on Package) and so on are pointed to as examples of types of semiconductor device to which the present invention is applied. The present invention can be applied to the semiconductor device that has these arbitrary product form and package form.

When the transistors that constitute a logic gate and the like are field effect transistors (FETs), various FETs are applicable, including MIS (Metal Insulator Semiconductor) and TFT (Thin Film Transistor) as well as MOS (Metal Oxide Semiconductor). The device may even include bipolar transistors.

In addition, an NMOS transistor (N-channel MOS transistor) is a representative example of a first conductive transistor, and a PMOS transistor (P-channel MOS transistor) is a representative example of a second conductive transistor.

Many combinations and selections of various constituent elements disclosed in this specification can be made within the scope of the appended claims of the present invention. That is, it is needles to mention that the present invention embraces the entire disclosure of this specification including the claims, as well as various changes and modifications which can be made by those skilled in the art based on the technical concept of the invention.

In addition, while not specifically claimed in the claim section, the applicant reserves the right to include in the claim section of the application at any appropriate time the following information processing systems:

A1. An information processing system comprising:

a semiconductor device that includes a memory cell array including a plurality of memory cells; and

a controller that controls the semiconductor device, wherein

the controller includes an output circuit that supplies the semiconductor device with an address signal indicating an address of a memory cell to access, a command signal indicating an access type, and a verification signal generated based on the address signal and the command signal,

the semiconductor device includes an access control circuit that performs an access operation to the memory cell array based on the address signal and the command signal, and

the access control circuit includes:
an active control circuit activating the memory cell array based on the address signal and the command signal;
a verification circuit that verifies the address signal and the command signal based on a verification signal supplied from outside; and
an error processing circuit that deactivates the memory cell array after a lapse of a predetermined time from a first time point when the verification result signal indicates a fail state at the first time point.

A2. The information processing system as described in A1, wherein

the command signal includes a write command to write data to the memory cells, and

the predetermined time is longer than or equal to time between when the write command is issued and when the data is written into the memory cells.

A3. The information processing system as described in A1 or A2, wherein

the command signal includes a read command to read out data from the memory cells, and

the predetermined time is longer than or equal to time between when the read command is issued and when the data that is read out is restored to the memory cells.

A4. The information processing system as described in A1, wherein

the command signal includes a write command to write data to the memory cells, and

the error processing circuit deactivates the memory cell array after the data is written into the memory cells based on the write command that is supplied before the first time point.

A5. The information processing system as described in A1 or A2, wherein

the command signal includes a read command to read out data from the memory cells, and

the error processing circuit deactivates the memory cell array after the data is read out from the memory cells based on the read command that is supplied before the first time point and the data that is read out is restored to the memory cells.

A6. The information processing system as described in any one of A1 to A5, wherein the semiconductor device disables the command signal when the verification result signal indicates the fail state.

What is claimed is:

1. A semiconductor device comprising on one chip:
a first external terminal receiving a command signal;
a second external terminal receiving an address signal;
a third external terminal receiving a parity bit related to at least one of the command signal and the address signal;
a memory cell array including a first group of memory cells activated by a first selection signal and a second group of memory cells activated by a second selection signal;
a verification circuit configured to be responsive to the parity bit and the related one of the command signal and the address signal to produce an error signal;
an error processing circuit configured to be responsive to the error signal to produce a follow-up signal; and
a control circuit configured to be responsive to the follow-up signal to deactivate the first and second groups of memory cells.

2. The semiconductor device as claimed in claim 1,
wherein the control circuit includes an active control circuit configured to set one of the first and second selection signal into a first state to activate an associated one of the first and second groups of memory cells in response to an activation command and a bank selection signal, and set the first and second selection signal into a second state to deactivate the first and second groups of memory cells in response to the follow-up signal.

3. The semiconductor device as claimed in claim 1,
wherein the error processing circuit includes a delay circuit which delays the error signal to produce the follow-up signal.

4. The semiconductor device as claimed in claim 3,
wherein the delay circuit includes a write latency shifter.

5. The semiconductor device as claimed in claim 4,
wherein the delay circuit includes a write recovery shifter.

6. The semiconductor device as claimed in claim 1, further comprising:
a fourth external terminal receiving a clock signal;
a fifth external terminal receiving a chip selection signal; and
a parity latency circuit configured to receive the clock signal, the chip selection signal, the error signal and one of the command signal and the address signal,
the parity latency circuit including,
a first latch chain receiving the chip selection signal, and a logic gate receiving an output the first latch chain and the error signal.

7. The semiconductor device as claimed in claim 6, further comprising:
a command decoder configured to produce a write command corresponding to the command signal inputted to the parity latency circuit, based on the command signal supplied from the first external terminal,
wherein the error processing circuit produces the follow-up signal by delaying the error signal with a period during a write operation, the period being from a timing when the command decoder generates the write command until the write operation associated to the write command is completed.

8. The semiconductor device as claimed in claim 1,
wherein the follow-up signal is a first follow-up signal;
wherein the error processing circuit produce a second follow-up signal being different in timing from the first follow-up signal.

9. The semiconductor device as claimed in claim 8, further comprising:
a write recovery shifter receiving the second follow-up signal.

10. The semiconductor device as claimed in claim 9, wherein a period between a first pulse of the first follow-up signal and a second pulse of the second follow-up signal generated based on the first pulse is determined by a write recovery latency.

11. A semiconductor device comprising on one chip:
a first external terminal supplied with a command signal;
a second external terminal supplied with an address signal;
a third external terminal supplied with a verification signal;
a memory cell array that includes a plurality of memory cells; and
an access control circuit that receives the address signal indicating an address of at least one of the memory cells to be accessed and the command signal indicating an access type, and accessing the memory cell array based on the address signal and the command signal, wherein the access control circuit includes:
an active control circuit activating the memory cell array based on the address signal and the command signal;
a verification circuit that verifies the address signal and the command signal based on the verification signal to output a verification result signal; and
an error processing circuit that deactivates the memory cell array after a lapse of a predetermined time from a first time point when the verification result signal indicates a fail state at the first time point.

12. The semiconductor device as claimed in claim 11, wherein
the command signal includes a write command to write data to the memory cells, and
the predetermined time is longer than or equal to time between when the write command is issued and when the data is written into the memory cells.

13. The semiconductor device as claimed in claim 11, wherein
the command signal includes a read command to read out data from the memory cells, and
the predetermined time is longer than or equal to time between when the read command is issued and when the data that is read out is restored to the memory cells.

14. The semiconductor device as claimed in claim 11, wherein
the command signal includes a write command to write data to the memory cells, and
the error processing circuit deactivates the memory cell array after the data is written into the memory cells based on the write command that is supplied before the first time point.

15. The semiconductor device as claimed in claim 11, wherein
the command signal includes a read command to read out data from the memory cells, and
the error processing circuit deactivates the memory cell array after the data is read out from the memory cells based on the read command that is supplied before the first time point and the data that is read out is restored to the memory cells.

16. The semiconductor device as claimed in claim 11, wherein the command signal is disabled when the verification result signal indicates the fail state.

17. A semiconductor device comprising:
a command decoder generating an internal command including a write command based on a verification result signal and an external command, the external command including a first bit and a plurality of second bits supplied from outside;
a verification circuit verifying the second bits to generate the verification result signal, the verification result signal indicating a fail state when the second bits include an error;
a plurality of memory banks each includes a plurality of memory cells, the memory banks being non-exclusively accessed based on the internal command;
a bank control circuit performing an activation operation to activate one or ones of the memory banks, a deactivation operation to deactivate one or ones of the memory banks, a read operation to read data from one of the memory banks, and a write operation to write data into one of the memory banks based on the internal command; and
an error processing circuit supplying a follow-up signal to the bank control circuit after a lapse of a first period and a second period when the verification result signal indicates the fail state during the write operation, wherein
the first period corresponds to a write latency indicating a period between when the write command is generated by the command decoder and when the data associated with the write command is supplied from outside, and
the second period corresponds to a write recovery latency indicating a period between when the bank control circuit issues a write execution signal to start writing the data to the memory cells and when the write operation is completed.

18. The semiconductor device as claimed in claim 17, wherein
the bank control circuit includes a column control circuit, an auto precharge control circuit, and an active control circuit,
the column control circuit includes:
a write latency shifter generating the write execution signal after a lapse of the write latency from receiving the write command; and
a first comparison circuit that compares a number of activation of the write commands with a number of activation of the write execution signals to generate a first control signal;
the auto precharge control circuit includes:
a write recovery shifter generating a write recovery completion signal after a lapse of the write recovery latency from receiving the write execution signal; and
a second comparison circuit that compares a number of activation of the write execution signals with a number of activation of the write recovery completion signals to generate a second control signal, and
the active control circuit generates a plurality of bank select signals to perform the activation operation or the deactivation operation based on an active command, an precharge command and the follow-up signal, the active command and the precharge commands being indicated by the internal command, the active command activating one or ones of the memory banks, and the precharge command deactivating one or ones of the memory banks.

19. The semiconductor device as claimed in claim 17, wherein the error processing circuit includes a write latency shifter that counts the write latency and a write recovery shifter that counts the write recovery latency.

20. The semiconductor device as claimed in claim 19, wherein the error processing circuit includes a first logic gate circuit that generates the follow-up signal based on the second control signal and the verification result signal.
